(19) United States
(12) Patent Application Publication
(10) Pub. No.: US 2009/0080960 A1
(43) Pub. Date: Mar. 26, 2009

(54) CONTROL METHOD AND APPARATUS FOR STRIP-SHAPED MATERIAL PRINTING PRESS

(76) Inventor: Osamu Yamamoto, Noda-shi (JP)

Correspondence Address: BIRCH STEWART KOLASCH & BIRCH, PO BOX 747, FALLS CHURCH, VA, 22040-0747, US

(21) Appl. No.: 12/210,347

(22) Filed: Sep. 15, 2008

(30) Foreign Application Priority Data
Sep. 20, 2007 (JP) 2007-243716
Jul. 29, 2008 (JP) 2008-194746

(51) Int. Cl. B41J 11/00

(52) U.S. Cl. 400/621

(57) ABSTRACT

A control apparatus for a web rotary printing press includes: a detector, located downstream of a former and provided halfway through a transport path for a web or a signature from the former to a chopper, for detecting the position of an end portion of the web on a side folded by the former; and a former and turn bar control device for adjusting the position, in the paper flow direction, of the former or the position, in the lateral direction, of the chopper in response to an output from the detector.

### BACKGROUND OF THE INVENTION

1. Field of the Invention

This invention relates to a control method and apparatus for a strip-shaped material printing press such as a web rotary printing press.

2. Description of the Related Art

In an offset rotary printing press, the air blowing amount of a former or a turn bar changes according to a change in the state of the printing press, such as the rotational speed of the printing press, whereby bulging of a web changes. As the state of the printing press changes accordingly, therefore, the position of a signature transported to a chopper folding unit of a folding machine changes.

Under these circumstances, it has been customary practice for an operator to manually adjust the position in the paper flow direction of the former or the turn bar, or the position in the lateral direction of the chopper (i.e., side lay), whenever the state of the printing press changes.

Examples of related prior art documents are JP-UM-A-63-190168, JP-A-63-57474, JP-A-64-8168, JP-A-59-179346, and JP-A-07-41247.

Thus, the problems have arisen that the operator has to perform constant monitoring and adjustment, and shoulder a heavy burden and, if the operator is late in finding the above change, there is a corresponding increase in the amount of wasted paper.

The present invention has been accomplished in light of the above-described problems. It is an object of the invention to enable the position in the strip-shaped material transport direction of a former or a turn bar, or the position, in a direction orthogonal to the signature transport direction, of a chopper (i.e., side lay), to be automatically adjusted in accordance with a change in the state of a printing press, thereby solving the aforementioned problems.

### SUMMARY OF THE INVENTION

A first aspect of the present invention is a control apparatus for a strip-shaped material printing press which includes,

printing means for printing a pattern on a strip-shaped material,

a former for folding the strip-shaped material, which has been printed by the printing means, in a direction parallel to a strip-shaped material transport direction,

cutting means for cutting the strip-shaped material, which has been folded by the former, in a direction orthogonal to the strip-shaped material transport direction to form a signature, and

a chopper folding device for refolding the signature, which has been formed by the cutting means, in a direction parallel to a signature transport direction,

the control apparatus, comprising:

paper end detecting means, provided halfway through a transport path for the strip-shaped material or the signature from the former to the chopper folding device, for detecting a position of an end portion of the strip-shaped material on a side folded by the former; and

control means for adjusting a position, in the strip-shaped material transport direction, of the former or a position, in a direction orthogonal to the signature transport direction, of the chopper folding device in response to an output from the paper end detecting means.

A second aspect of the present invention is a control apparatus for a strip-shaped material printing press which includes,

printing means for printing a pattern on a strip-shaped material,

a turn bar for changing a transport direction of the strip-shaped material,

cutting means for cutting the strip-shaped material, which has been changed in the transport direction by the turn bar, in a direction orthogonal to the strip-shaped material transport direction to form a signature, and

a chopper folding device for folding the signature, which has been formed by the cutting means, in a direction parallel to a signature transport direction,

the control apparatus, comprising:

paper end detecting means, provided halfway through a transport path for the strip-shaped material or the signature from the turn bar to the chopper folding device, for detecting a position of an end portion of the strip-shaped material or the signature parallel to the transport direction; and

control means for adjusting a position, in the strip-shaped material transport direction, of the turn bar or a position, in a direction orthogonal to the signature transport direction, of the chopper folding device in response to an output from the paper end detecting means.

A third aspect of the present invention is a control method for a strip-shaped material printing press which includes,

printing means for printing a pattern on a strip-shaped material,

a former for folding the strip-shaped material, which has been printed by the printing means, in a direction parallel to a strip-shaped material transport direction,

cutting means for cutting the strip-shaped material, which has been folded by the former, in a direction orthogonal to the strip-shaped material transport direction to form a signature, and

a chopper folding device for refolding the signature, which has been formed by the cutting means, in a direction parallel to a signature transport direction,

the control method, comprising:

detecting a position of an end portion of the strip-shaped material on a side folded by the former, halfway through a transport path for the strip-shaped material or the signature from the former to the chopper folding device; and

adjusting a position, in the strip-shaped material transport direction, of the former or a position, in a direction orthogonal to the signature transport direction, of the chopper folding device in accordance with results of detection.

A fourth aspect of the present invention is a control method for a strip-shaped material printing press which includes,

printing means for printing a pattern on a strip-shaped material,

a turn bar for changing a transport direction of the strip-shaped material,

cutting means for cutting the strip-shaped material, which has been changed in the transport direction by the turn bar, in a direction orthogonal to the strip-shaped material transport direction to form a signature, and

a chopper folding device for folding the signature, which has been formed by the cutting means, in a direction parallel to a signature transport direction,

the control method, comprising:

detecting a position of an end portion of the strip-shaped material or the signature parallel to the transport direction, halfway through a transport path for the strip-shaped material or the signature from the turn bar to the chopper folding device; and

adjusting a position, in the strip-shaped material transport direction, of the turn bar or a position, in a direction orthogonal to the signature transport direction, of the chopper folding device in accordance with results of detection.

According to the above-described features of the present invention, the position in the strip-shaped material transport direction of the former or the turn bar, or the position, in a direction orthogonal to the signature transport direction, (i.e., side lay) of the chopper can be automatically adjusted in accordance with a change in the state of the printing press, whereby the folding position of the signature transported to the chopper can be kept always constant. As a result, the burden on the operator is lessened, the rate of operation is increased, and increases in wasted paper can be curbed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a block diagram of a former and turn bar control device showing Embodiment 1 of the present invention;

FIG. 1B is a block diagram of the former and turn bar control device;

FIG. 2A is a motion flow chart of the former and turn bar control device;

FIG. 2B is a motion flow chart of the former and turn bar control device;

FIG. 2C is a motion flow chart of the former and turn bar control device;

FIG. 2D is a motion flow chart of the former and turn bar control device;

FIG. 3A is a motion flow chart of the former and turn bar control device;

FIG. 3B is a motion flow chart of the former and turn bar control device;

FIG. 3C is a motion flow chart of the former and turn bar control device;

FIG. 3D is a motion flow chart of the former and turn bar control device;

FIG. 4A is a motion flow chart of the former and turn bar control device;

FIG. 4B is a motion flow chart of the former and turn bar control device;

FIG. 5A is a motion flow chart of the former and turn bar control device;

FIG. 5B is a motion flow chart of the former and turn bar control device;

FIG. 6A is a block diagram of a chopper control device showing Embodiment 2 of the present invention;

FIG. 6B is a block diagram of the chopper control device;

FIG. 7A is a motion flow chart of the chopper control device;

FIG. 7B is a motion flow chart of the chopper control device;

FIG. 7C is a motion flow chart of the chopper control device;

FIG. 7D is a motion flow chart of the chopper control device;

FIG. 8A is a motion flow chart of the chopper control device;

FIG. 8B is a motion flow chart of the chopper control device;

FIG. 8C is a motion flow chart of the chopper control device;

FIG. 8D is a motion flow chart of the chopper control device;

FIG. 9A is a motion flow chart of the chopper control device;

FIG. 9B is a motion flow chart of the chopper control device;

FIG. 10A is a motion flow chart of the chopper control device;

FIG. 10B is a motion flow chart of the chopper control device;

FIG. 11 is a perspective view of a folding machine in a web rotary printing press;

FIG. 12 is an explanation drawing of an air blowing device of the former;

FIG. 13 is an explanation drawing of a moving mechanism of the former;

FIG. 14 is an explanation drawing of an air blowing device of the turn bar;

FIG. 15 is an explanation drawing of a moving mechanism of the turn bar; and

FIG. 16 is an explanation drawing of a moving mechanism of the chopper.

### DETAILED DESCRIPTION OF THE INVENTION

The control method and apparatus for a strip-shaped material printing press according to the present invention will be described in detail by preferred embodiments of the invention by reference to the accompanying drawings.

### Embodiment 1

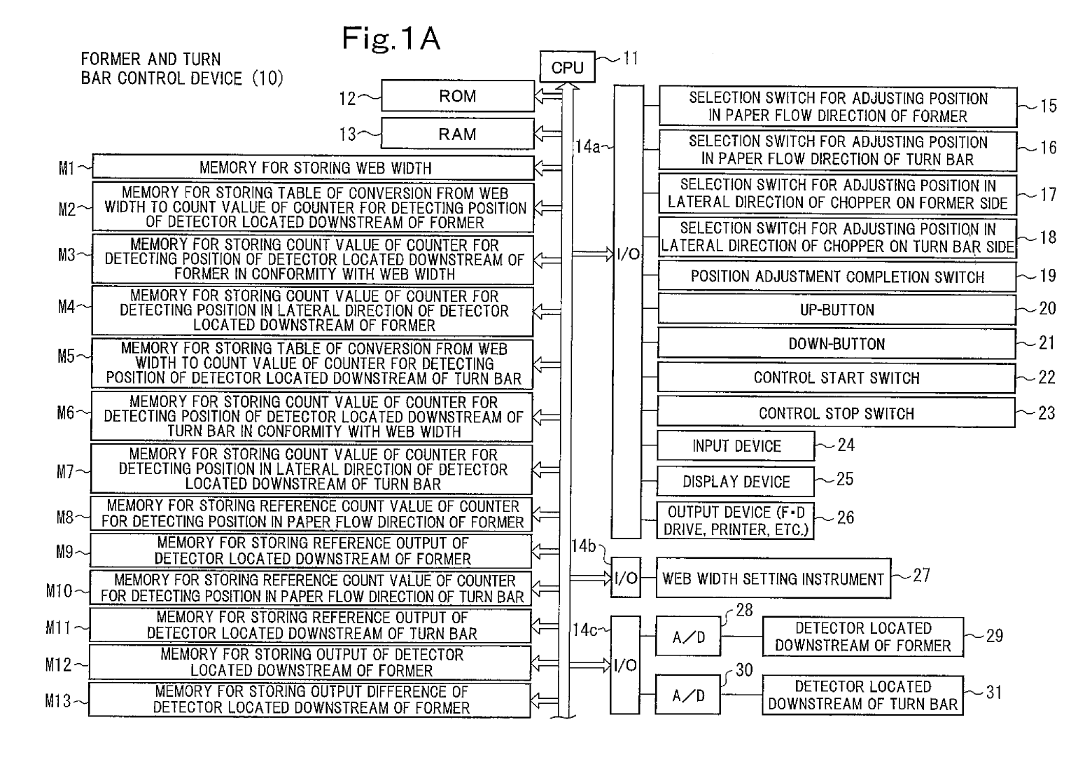

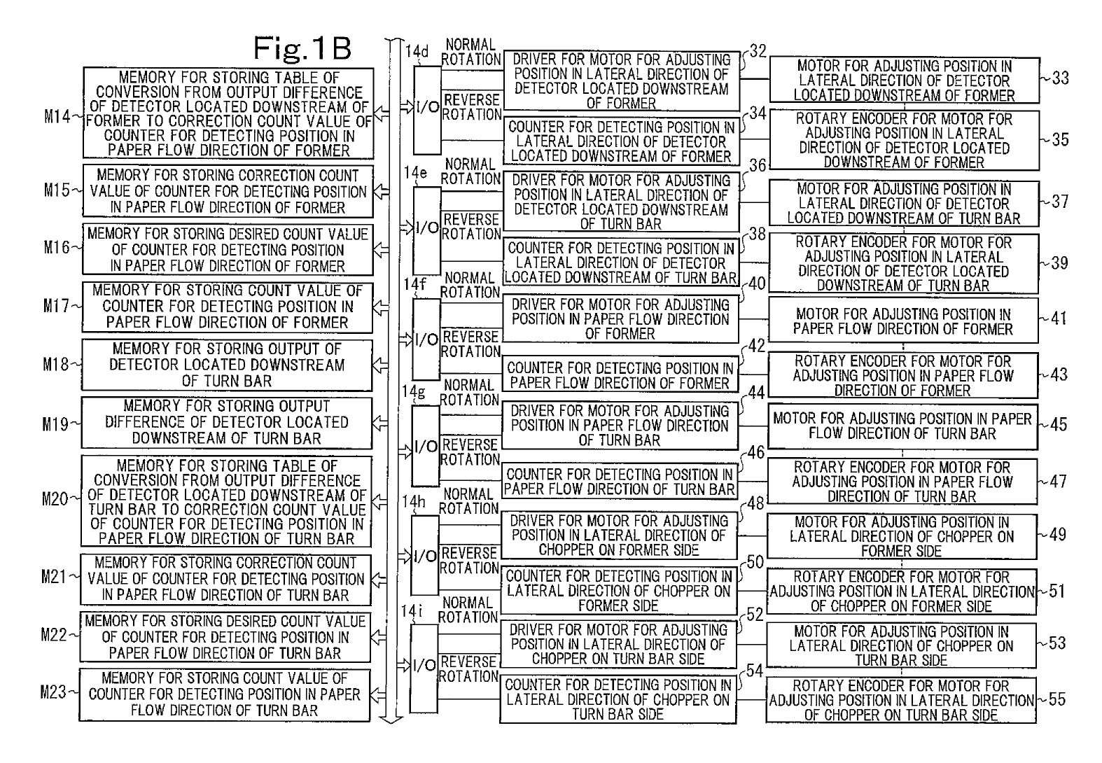

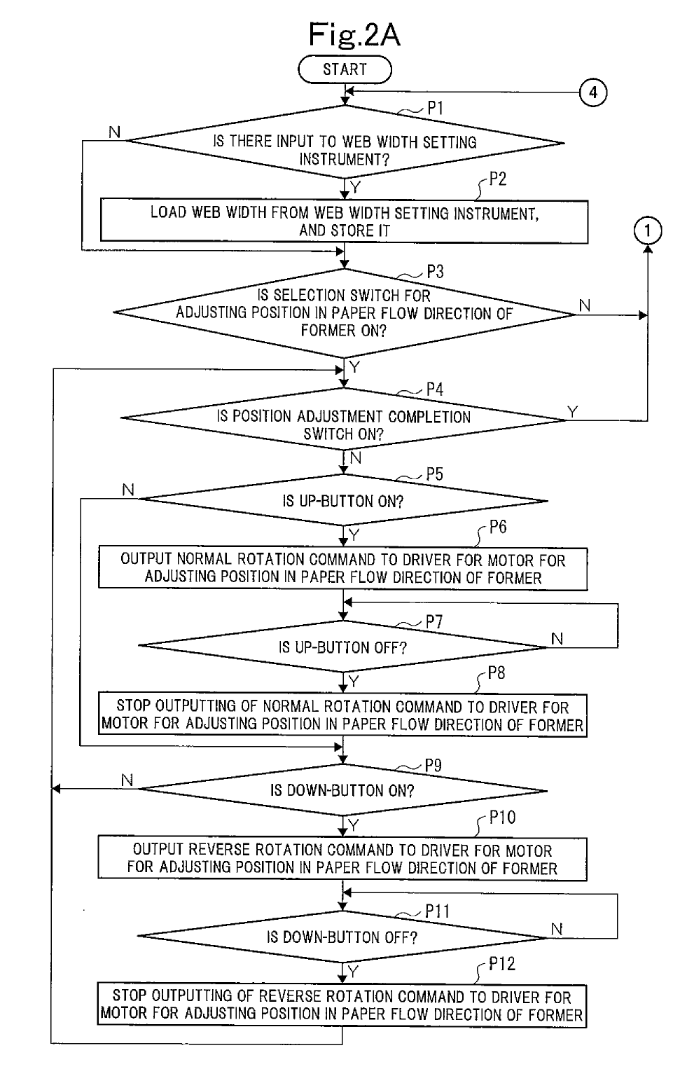

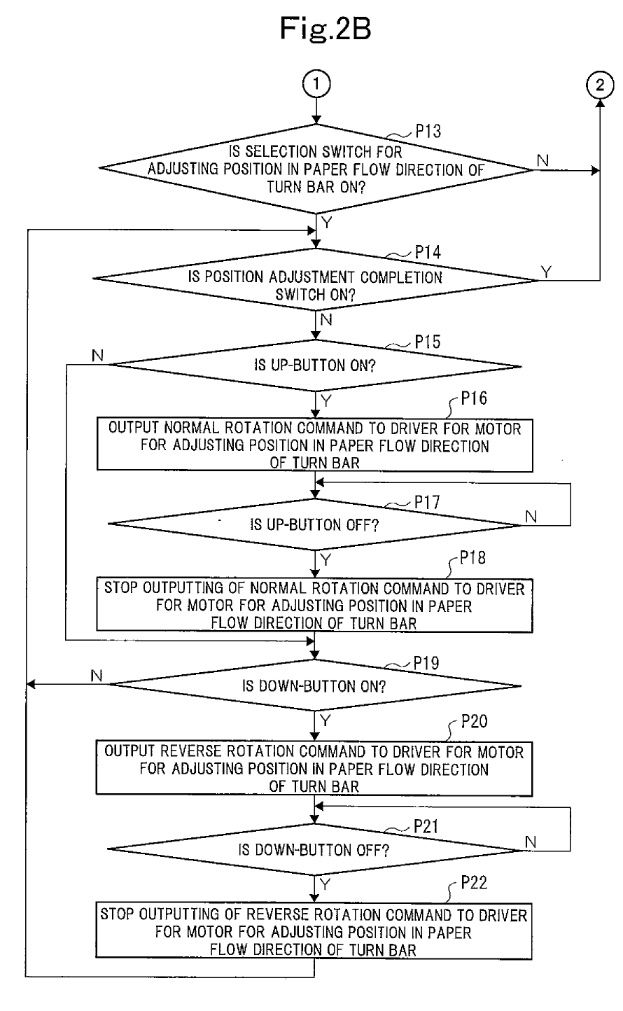

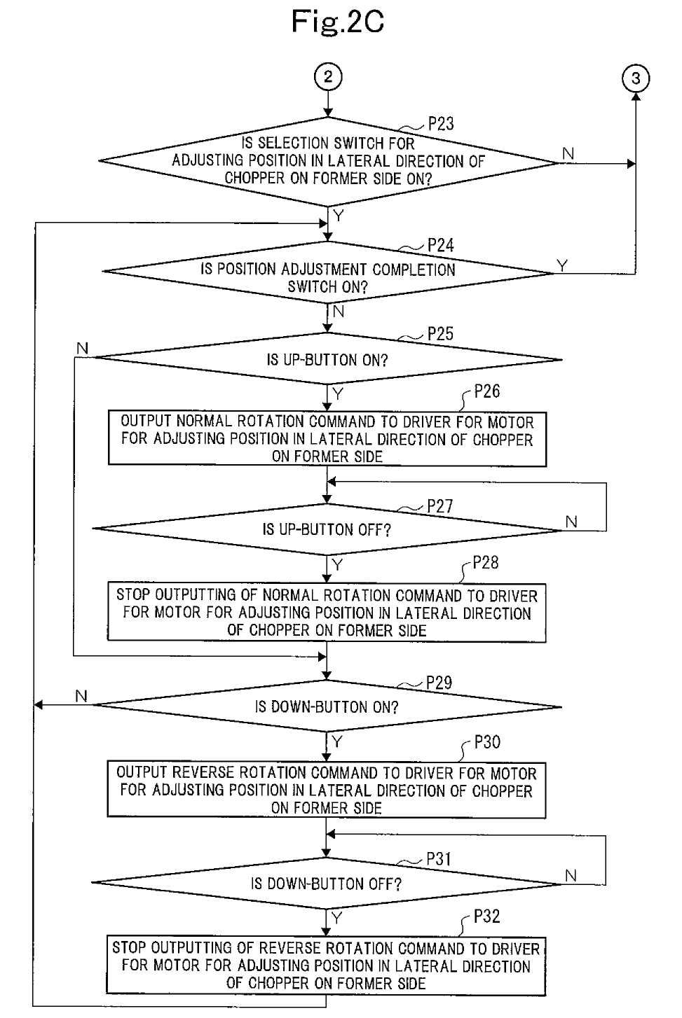

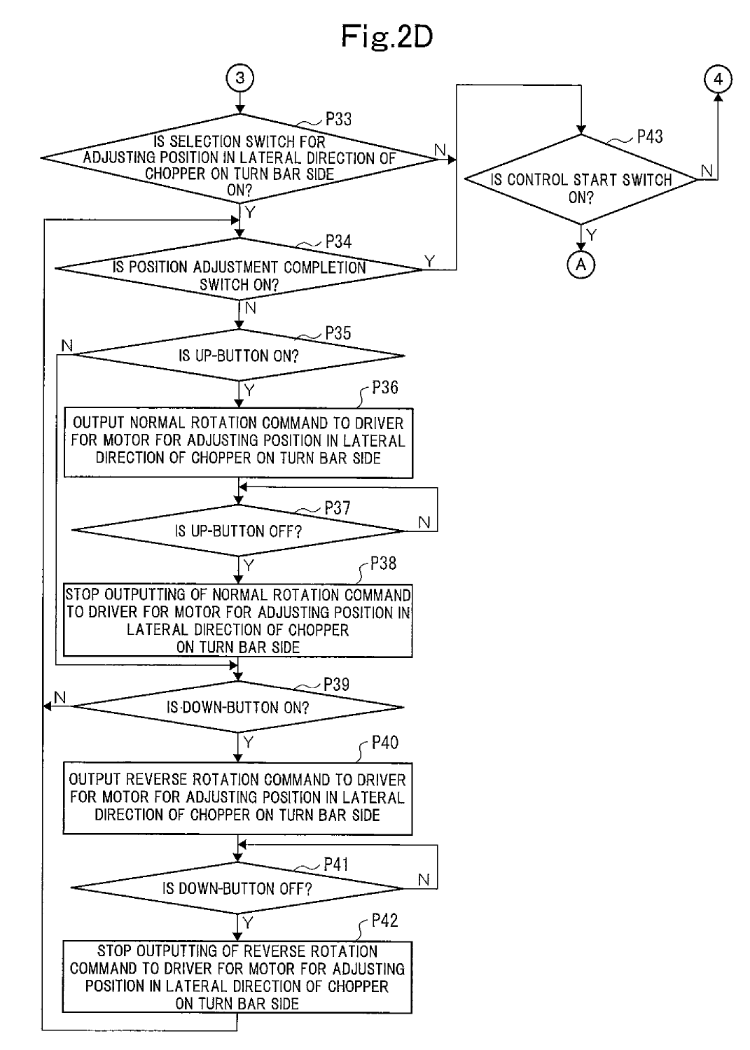

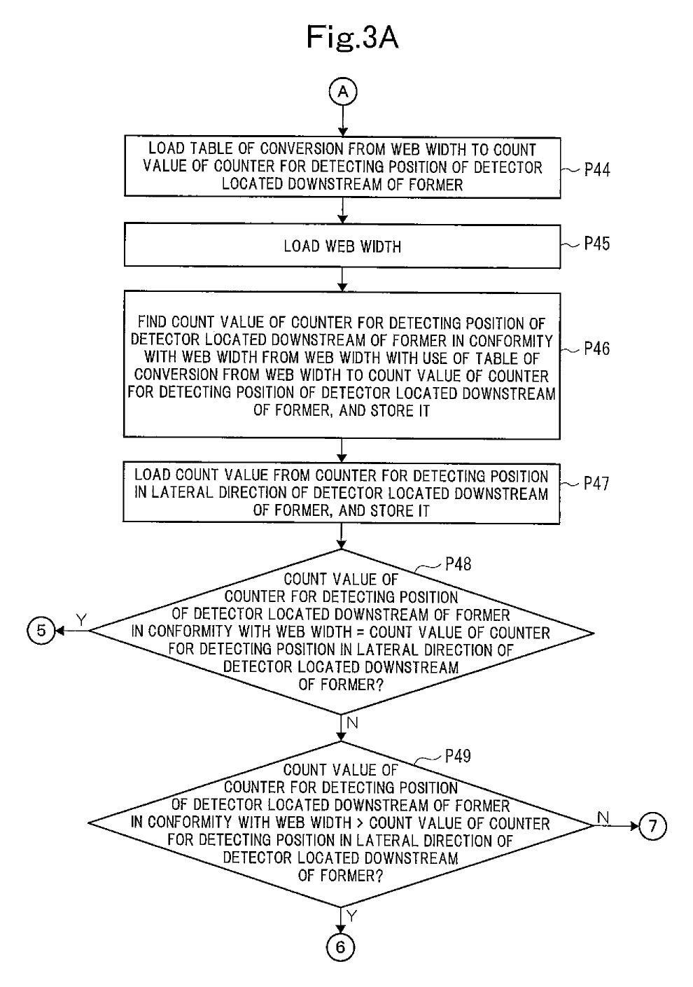

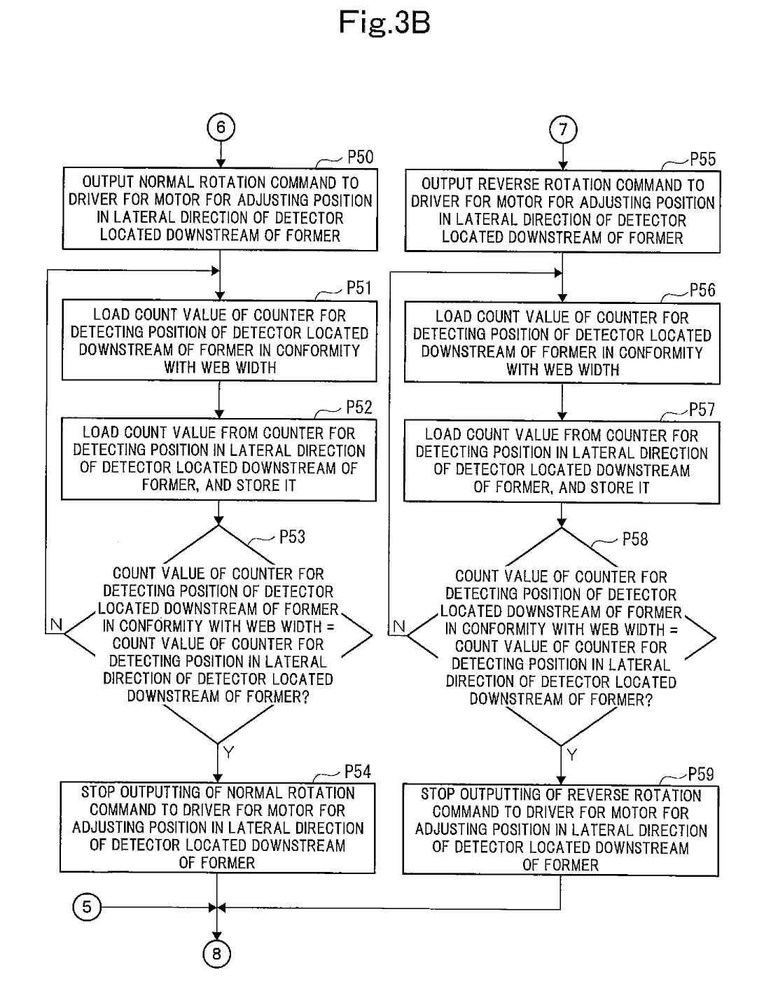

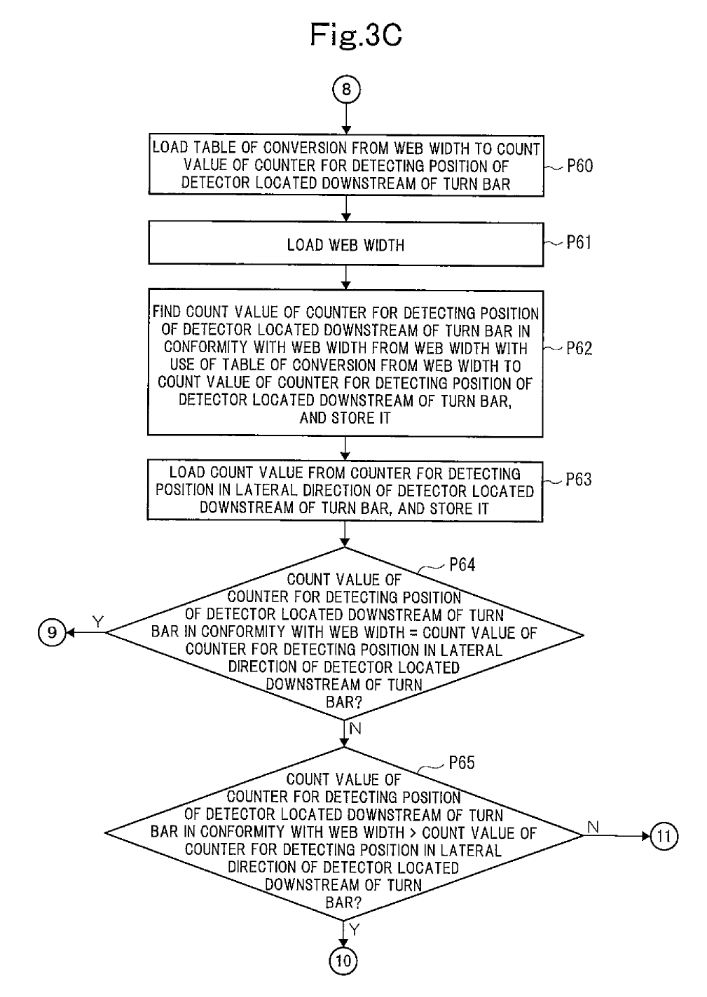

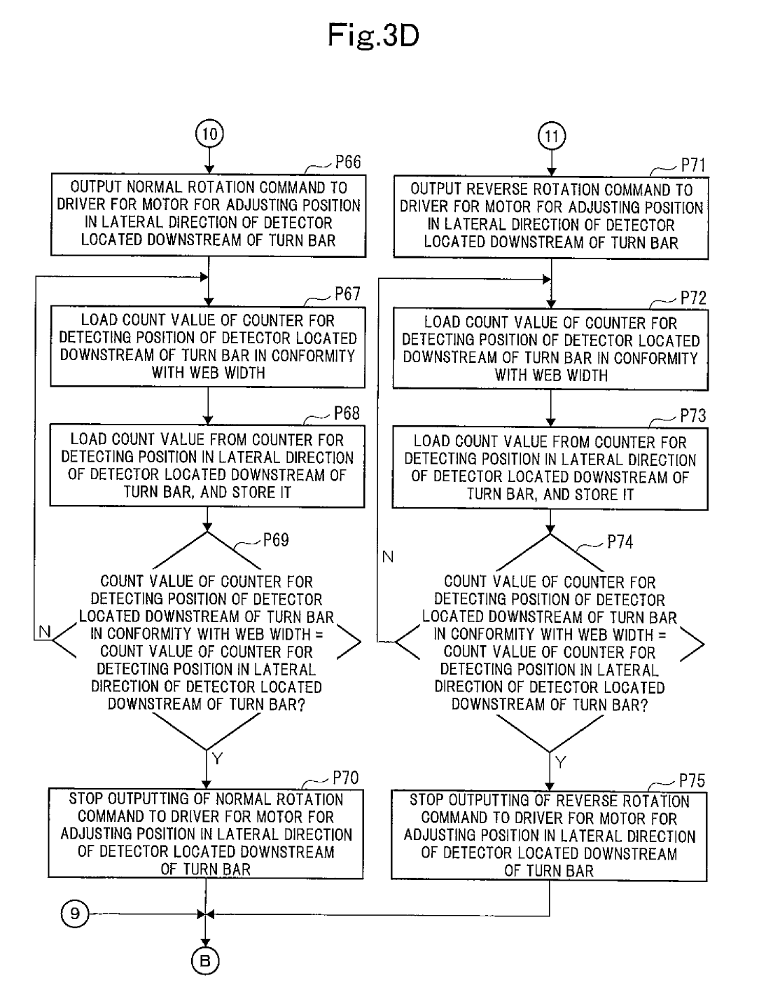

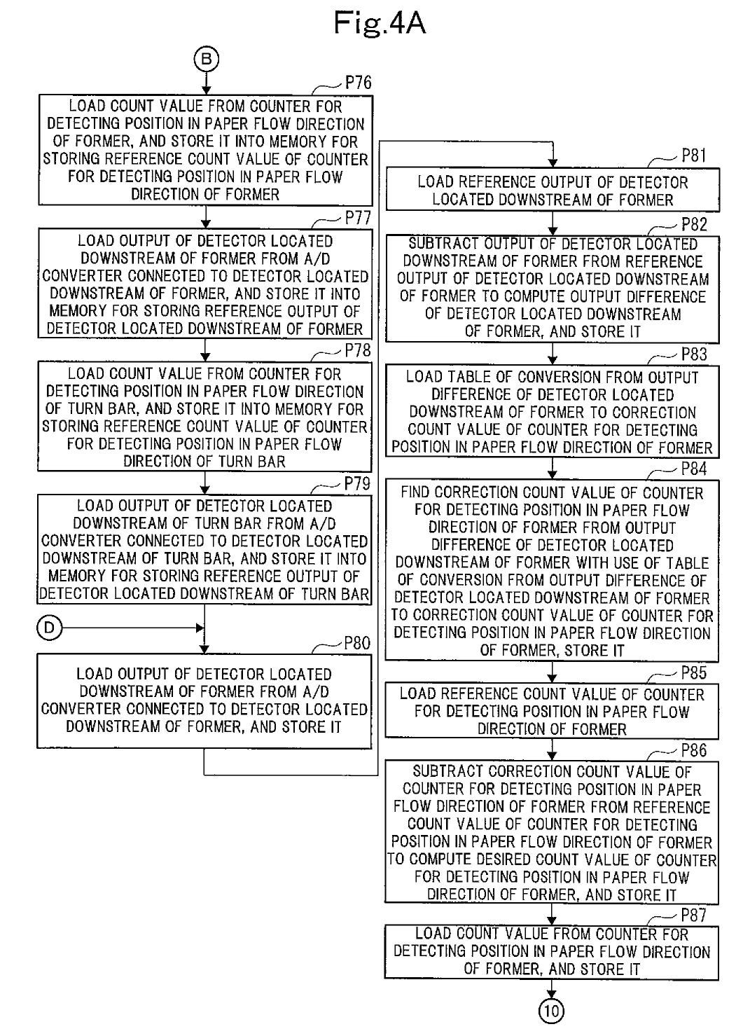

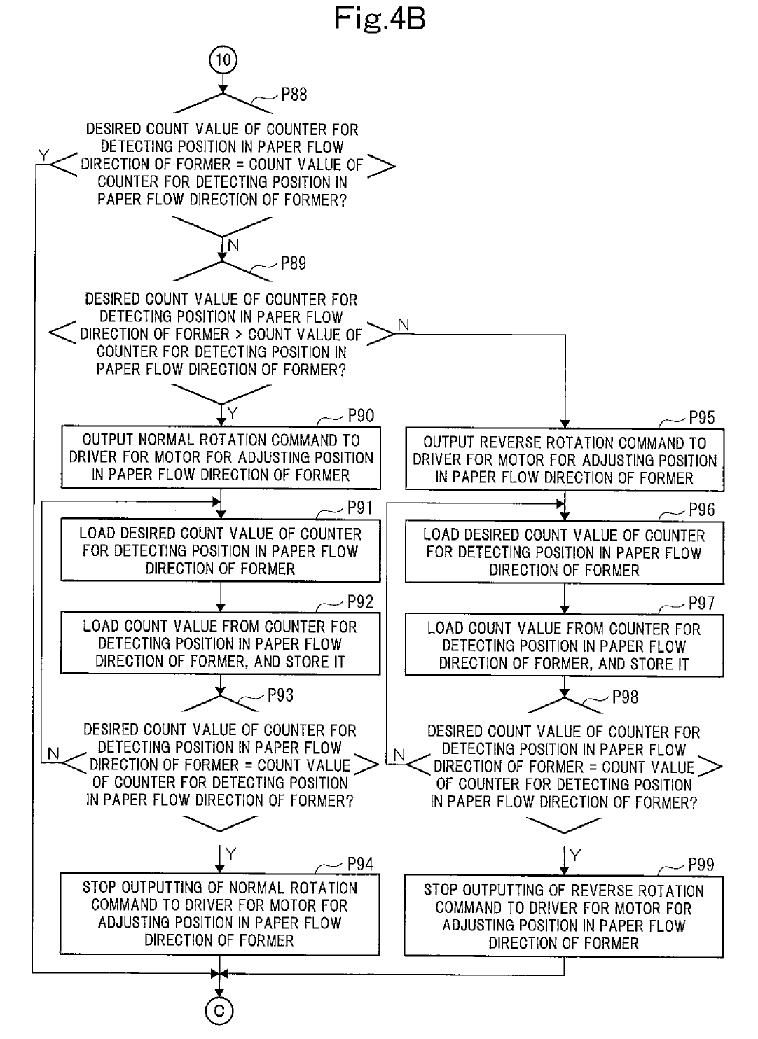

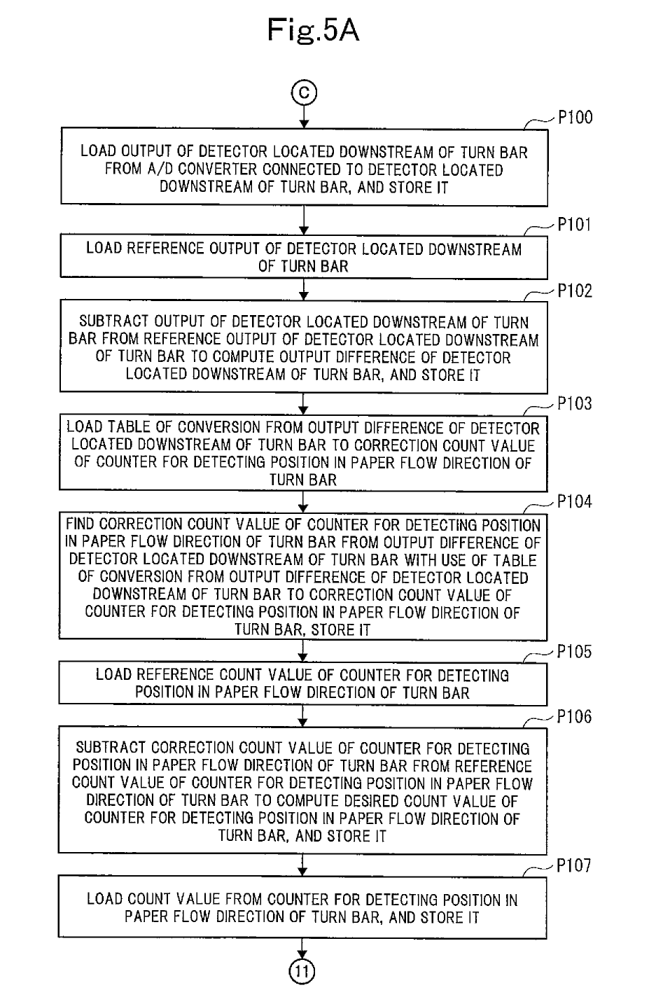

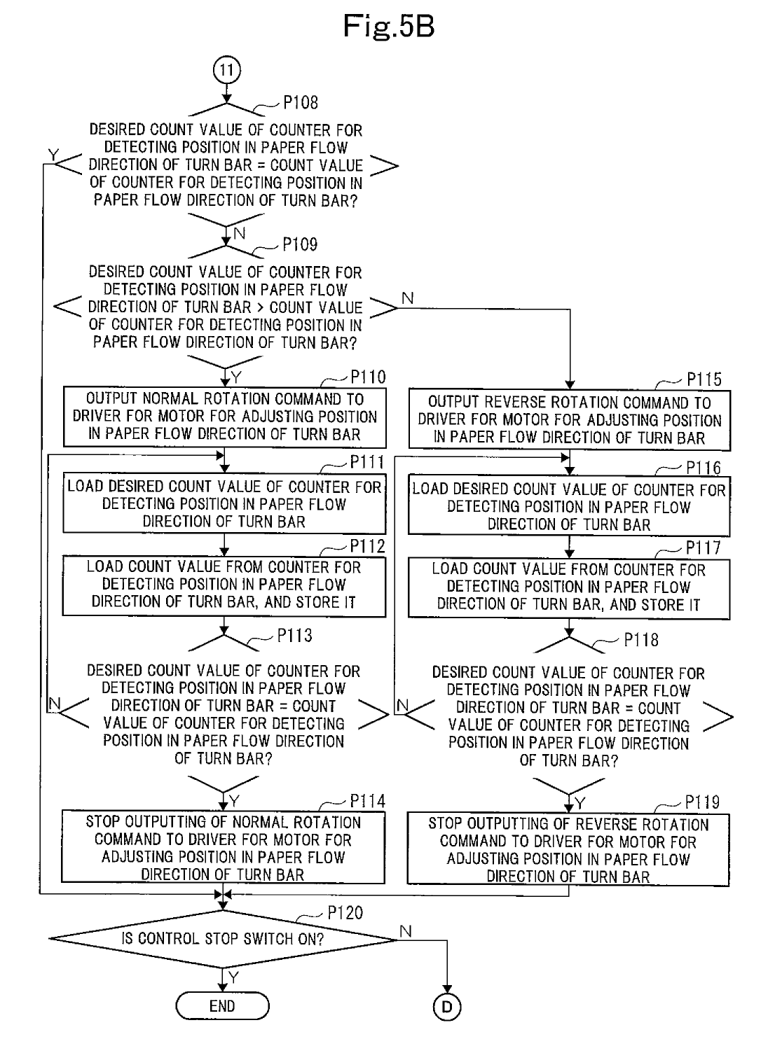

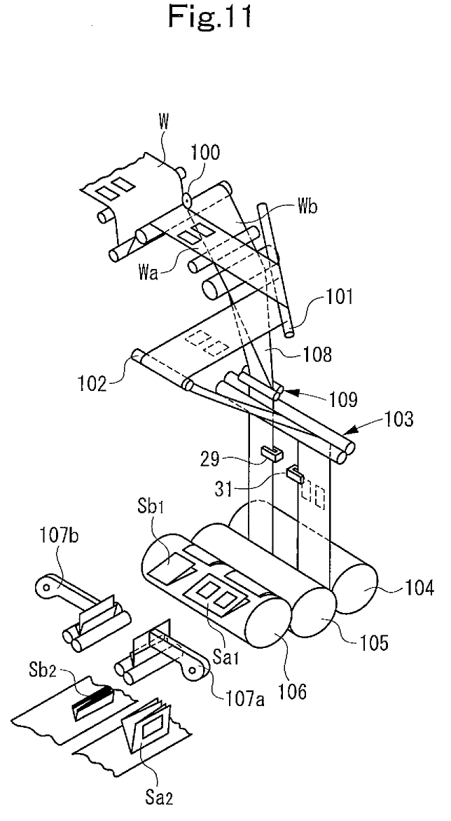

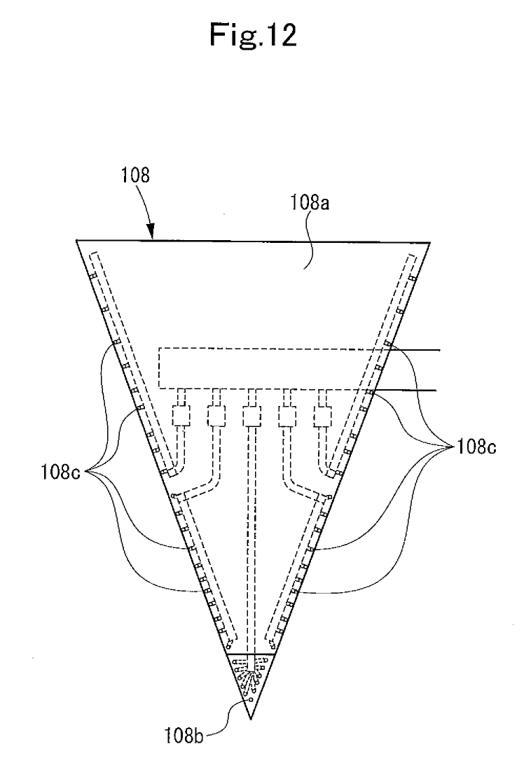

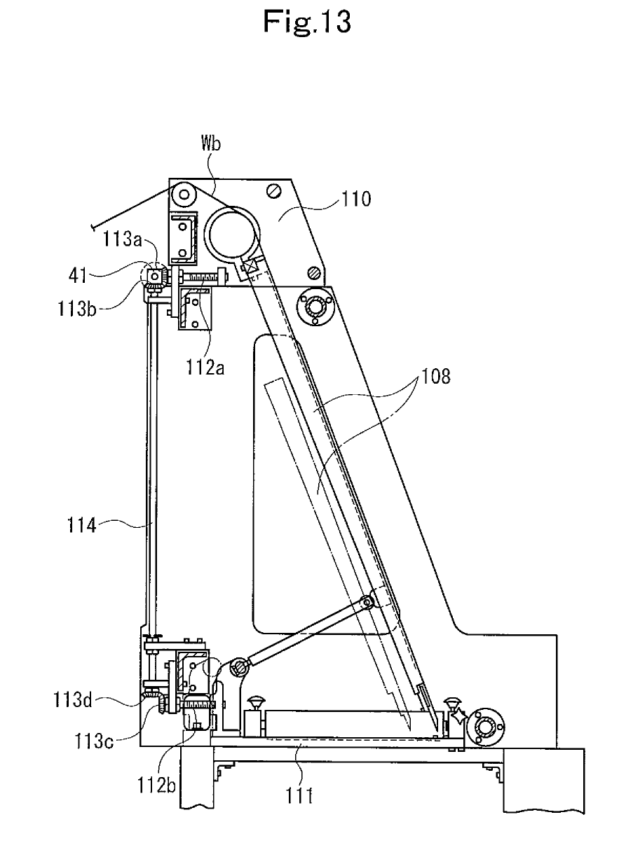

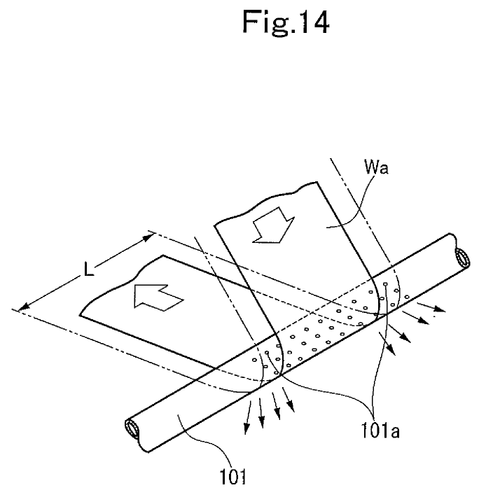

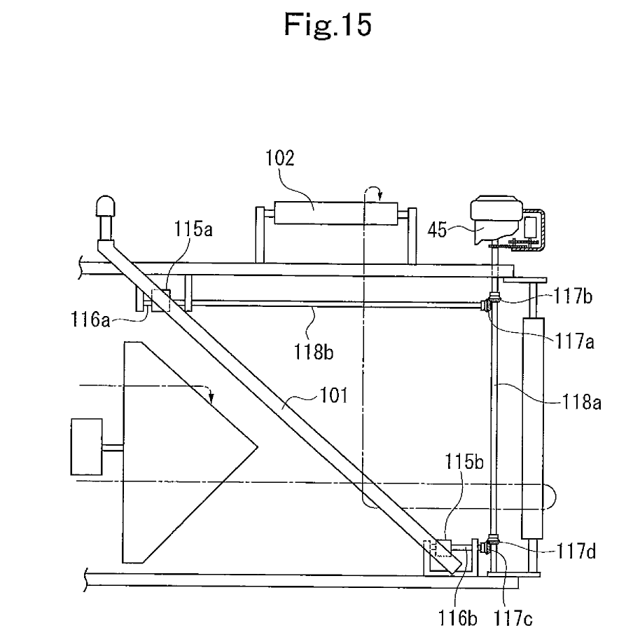

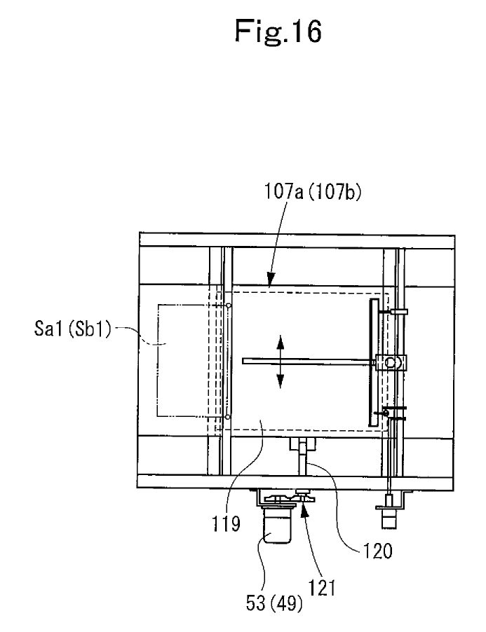

FIGS. 1A and 1B are block diagrams of a former and turn bar control device showing Embodiment 1 of the present invention. FIGS. 2A to 2D are motion flow charts of the former and turn bar control device. FIGS. 3A to 3D are motion flow charts of the former and turn bar control device. FIGS. 4A and 4B are motion flow charts of the former and turn bar control device. FIGS. 5A and 5B are motion flow charts of the former and turn bar control device. FIG. 11 is a perspective view of a folding machine in a web rotary printing press. FIG. 12 is an explanation drawing of an air blowing device of the former. FIG.13 is an explanation drawing of a moving mechanism of the former. FIG. 14 is an explanation drawing of an air blowing device of the turn bar. FIG. 15 is an explanation drawing of a moving mechanism of the turn bar. FIG. 16 is an explanation drawing of a moving mechanism of the chopper.

As shown in FIG. 11, a web (strip-shaped material) W, which has been fed to a folding machine of a web rotary printing press (strip-shaped material printing press) having plural-color printing units (printing means) for printing a pattern on the web W, is cut into halves in the width direction by a slitter 100. Then, one of the halves (i.e., web Wa) is changed in direction to a perpendicular direction by a turn bar 101, and is guided to a folding unit via a guide roller 102 and a nipping roller 103. Then, the web Wa is cut and single parallel-folded by a cut-off cylinder (cutting means) 104, a folding cylinder 105, and a jaw cylinder 106 of the folding unit, and is discharged as a 4-page signature Sa1. Further, the signature Sa1 is chopper-folded in a perpendicular direction by a chopper (chopper folding device) 107a, and is discharged as an 8-page signature Sa2.

The other half (i.e., web Wb) is fed to a former 108, where the halves of the web Wb are superposed with their backs opposing each other, and is guided to the folding unit via a lead roller 109 and the nipping roller 103 to be cut and single parallel-folded. As a result, an 8-page signature Sb1 is discharged, and this signature Sb1 is further chopper-folded in a perpendicular direction by a chopper (chopper folding device) 107b, whereupon it is discharged as a 16-page signature Sb2.

The former 108, as shown in FIG. 12, has many air blowoff ports 108c formed in right and left shoulder portions of a body 108a and a nose 108b. By the action of air blown off through these air blowoff ports 108c, the other web Wb is transported and former-folded in a floating state. As shown in FIG. 13, a subframe 110 for supporting an upper end portion of the former 108, and a base 111 for supporting a lower end portion of the former 108 are provided to be integrally movable in a lateral direction in the drawing by a drive mechanism which comprises feed screws 112a, 112b, bevel gears 113a to 113d, a vertical shaft 114, and a motor 41 (see FIG. 1B) for adjusting the position in a paper flow direction of the former. Thus, the position in the paper flow direction (the position in the strip-shaped material transport direction) of the former 108 can be adjusted. The concrete structure of the air blowing device of the former 108 is publicly known from the aforementioned JP-UM-A-63-190168, and the concrete structure of the moving mechanism of the former 108 is publicly known from the aforementioned JP-A-63-57474. Detailed descriptions of them will be known by reference to these documents, and they are omitted herein.

The turn bar 101, as shown in FIG. 14, has many air blowoff ports 101a formed in a range of a predetermined length L in a surface of the turn bar 101 over which the one web Wa is passed. By the action of air blown off through these air blowoff ports 101a, the one web Wa is transported in a floating state. As shown in FIG. 15, bosses 115a, 115b for supporting right and left portions of the turn bar 101 are provided to be integrally movable in a lateral direction in the drawing by a drive mechanism which comprises feed screws 116a, 116b, bevel gears 117a to 117d, horizontal shafts 118a, 118b, and a motor 45 (see FIG. 1B) for adjusting the position in the paper flow direction of the turn bar. Thus, the position in the paper flow direction (the position in the strip-shaped material transport direction) of the turn bar 101 can be adjusted. The concrete structure of the air blowing device of the turn bar 101 is publicly known from the aforementioned JP-A-64-8168, and the concrete structure of the moving mechanism of the turn bar 101 is publicly known from the aforementioned JP-A-59-179346. Detailed descriptions of them will be known by reference to these documents, and they are omitted herein.

The chopper (chopper folding device) 107a or 107b has a chopper upper table 119 for supporting a chopper blade or the like (not shown). As shown in FIG. 16, the chopper upper table 119 is provided to be movable in a vertical direction in the drawing by a drive mechanism which comprises a feed screw 120, a gear mechanism 121, and a motor 53 or 49 (see FIG. 1B) for adjusting the position in the lateral direction of the chopper on the turn bar side or the chopper on the former side. Thus, the position in the lateral direction (the position in a direction orthogonal to the signature transport direction) of the chopper on the turn bar side or the chopper on the former side can be adjusted. The concrete structure of the moving mechanism of the chopper 107a or 107b is publicly known from the aforementioned JP-A-07-41247. Its detailed description will be known by reference to this document, and is omitted herein.

The present embodiment shows an example in which a detector 31 located downstream of the turn bar is provided at an end portion of the web Wa closer to the center in the lateral direction of the web W (a direction orthogonal to the transport direction of the web W) before being cut into halves by the slitter 100. However, this detector 31 may be provide at an end portion farther from this center. In this case, however, there will occur an error in the partial length in the lateral direction of the web W during production, or a detection error due to a variation in the elongation in the lateral direction of the web W during printing. As in the present embodiment, therefore, it is desirable to provide the detector 31 at the end portion closer to the center in the lateral direction of the web W. In the present embodiment, as shown in FIG. 11, the above detector (an ultrasonic edge position detector or the like; a paper end detecting means) 31 located downstream of the turn bar for detecting the position of an end portion (outward portion) of the one web Wa parallel to the transport direction, and a detector (an ultrasonic edge position detector or the like; a paper end detecting means) 29 located downstream of the former for detecting the position of an end portion (inward portion) of the other web Wb folded by the former 108 are provided halfway through the web transport path between the nipping roller 103 and the cut-off cylinder 104 and the folding cylinder 105 of the folding unit.

The detector 31 located downstream of the turn bar and the detector 29 located downstream of the former are provided to be movable in the width direction of the webs Wa, Wb by a motor 37 (see FIG. 1B) for adjusting the position in the lateral direction of the detector located downstream of the turn bar, and a motor 33 (see FIG. 1B) for adjusting the position in the lateral direction of the detector located downstream of the former. Thus, their positions in the lateral direction can be adjusted.

The motor 45 for adjusting the position in the paper flow direction of the turn bar, the motor 41 for adjusting the position in the paper flow direction of the former, the motors 53, 49 for adjusting the positions in the lateral direction of the chopper on the turn bar side and the chopper on the former side, the motor 37 for adjusting the position in the lateral direction of the detector located downstream of the turn bar, and the motor 33 for adjusting the position in the lateral direction of the detector located downstream of the former are controlled to be driven by a former and turn bar control device (control means) 10 to be described later.

The former and turn bar control device 10 adjusts (controls) the position in the paper flow direction (position in the strip-shaped material transport direction) of the turn bar 101, and the position in the paper flow direction (position in the strip-shaped material transport direction) of the former 10, in response to detection signals from the detector 31 located downstream of the turn bar and the detector 29 located downstream of the former, respectively.

That is, the former and turn bar control device 10 comprises CPU 11, ROM 12, RAM 13, and input/output devices 14a to 14i connected together by BUS (bus line), as shown in FIGS. 1A and 1B.

To the BUS (bus line), the following memories are connected: A memory M1 for storing the web width, a memory M2 for storing a table of conversion from the web width to the count value of a counter for detecting the position of the detector located downstream of the former, a memory M3 for storing the count value of the counter for detecting the position of the detector located downstream of the former in conformity with the web width, a memory M4 for storing the count value of a counter for detecting the position in the lateral direction of the detector located downstream of the former, a memory M5 for storing a table of conversion from the web width to the count value of a counter for detecting the position of the detector located downstream of the turn bar, a memory M6 for storing the count value of the counter for detecting the position of the detector located downstream of the turn bar in conformity with the web width, a memory M7 for storing the count value of a counter for detecting the position in the lateral direction of the detector located downstream of the turn bar, a memory M8 for storing the reference count value of a counter for detecting the position in the paper flow direction of the former, a memory M9 for storing the reference output of the detector located downstream of the former, a memory M10 for storing the reference count value of a counter for detecting the position in the paper flow direction of the turn bar, and a memory M11 for storing the reference output of the detector located downstream of the turn bar.

To the BUS (bus line), the following memories are further connected: A memory M12 for storing the output of the detector located downstream of the former, a memory M13 for storing the output difference of the detector located downstream of the former, a memory M14 for storing a table of conversion from the output difference of the detector located downstream of the former to the correction count value of the counter for detecting the position in the paper flow direction of the former, a memory M15 for storing the correction count value of the counter for detecting the position in the paper flow direction of the former, a memory M16 for storing the desired count value of the counter for detecting the position in the paper flow direction of the former, a memory M17 for storing the count value of the counter for detecting the position in the paper flow direction of the former, a memory M18 for storing the output of the detector located downstream of the turn bar, a memory M19 for storing the output difference of the detector located downstream of the turn bar, a memory M20 for storing a table of conversion from the output difference of the detector located downstream of the turn bar to the correction count value of the counter for detecting the position in the paper flow direction of the turn bar, a memory M21 for storing the correction count value of the counter for detecting the position in the paper flow direction of the turn bar, a memory M22 for storing the desired count value of the counter for detecting the position in the paper flow direction of the turn bar, and a memory M23 for storing the count value of the counter for detecting the position in the paper flow direction of the turn bar.

To the input/output device 14a, the following are connected: A selection switch 15 for adjusting the position in the paper flow direction of the former, a selection switch 16 for adjusting the position in the paper flow direction of the turn bar, a selection switch 17 for adjusting the position in the lateral direction of the chopper on the former side, a selection switch 18 for adjusting the position in the lateral direction of the chopper on the turn bar side, a position adjustment completion switch 19, an up-button 20, a down-button 21, a control start switch 22, a control stop switch 23, an input device 24 such as a keyboard, a display device 25 such as a CRT display, and an output device 26 such as a printer and a floppy disk (registered trademark) drive.

To the input/output device 14b, a web width setting instrument 27 is connected.

To the input/output device 14c, the detector 29 located downstream of the former is connected via an A/D converter 28, and the detector 31 located downstream of the turn bar is connected via an A/D converter 30.

To the input/output device 14d, the motor 33 for adjusting the position in the lateral direction of the detector located downstream of the former is connected via a driver 32 for the motor for adjusting the position in the lateral direction of the detector located downstream of the former, and a rotary encoder 35 for the motor for adjusting the position in the lateral direction of the detector located downstream of the former is connected via a counter 34 for detecting the position in the lateral direction of the detector located downstream of the former.

To the input/output device 14e, the motor 37 for adjusting the position in the lateral direction of the detector located downstream of the turn bar is connected via a driver 36 for the motor for adjusting the position in the lateral direction of the detector located downstream of the turn bar, and a rotary encoder 39 for the motor for adjusting the position in the lateral direction of the detector located downstream of the turn bar is connected via a counter 38 for detecting the position in the lateral direction of the detector located downstream of the turn bar.

To the input/output device 14f, the motor 41 for adjusting the position in the paper flow direction of the former is connected via a driver 40 for the motor for adjusting the position in the paper flow direction of the former, and a rotary encoder 43 for the motor for adjusting the position in the paper flow direction of the former is connected via a counter 42 for detecting the position in the paper flow direction of the former.

To the input/output device 14g, the motor 45 for adjusting the position in the paper flow direction of the turn bar is connected via a driver 44 for the motor for adjusting the position in the paper flow direction of the turn bar, and a rotary encoder 47 for the motor for adjusting the position in the paper flow direction of the turn bar is connected via a counter 46 for detecting the position in the paper flow direction of the turn bar.

To the input/output device 14h, the motor 49 for adjusting the position in the lateral direction of the chopper on the former side is connected via a driver 48 for the motor for adjusting the position in the lateral direction of the chopper on the former side, and a rotary encoder 51 for the motor for adjusting the position in the lateral direction of the chopper on the former side is connected via a counter 50 for detecting the position in the lateral direction of the chopper on the former side.

To the input/output device 14i, the motor 53 for adjusting the position in the lateral direction of the chopper on the turn bar side is connected via a driver 52 for the motor for adjusting the position in the lateral direction of the chopper on the turn bar side, and a rotary encoder 55 for the motor for adjusting the position in the lateral direction of the chopper on the turn bar side is connected via a counter 54 for detecting the position in the lateral direction of the chopper on the turn bar side.

The control actions or motions of the former and turn bar control device 10 of the above configuration will be described in detail in accordance with the motion flow charts of FIGS. 2A to 2D, 3A to 3D, 4A and 4B, and 5A and 5B.

In Step P1, it is determined whether there is an input to the web width setting instrument 27. If the answer is Y (yes), the web width is loaded from the web width setting instrument 27, and stored into the memory M1, in Step P2. Then, the program proceeds to Step P3. If the answer is N (no), the program directly shifts to Step P3.

Then, in Step P3, it is determined whether the selection switch 15 for adjusting the position in the paper flow direction of the former has been turned on. If the answer is Y, it is determined in Step P4 whether the position adjustment completion switch 19 has been turned on. If the answer is N in Step P3, the program shifts to Step P13 to be described later.

If the answer is Y in Step P4, the program shifts to Step P13 to be described later. If the answer is N in Step P4, it is determined in Step P5 whether the up-button 20 has been turned on.

If the answer is Y in Step P5, Step P6 is executed to output a normal rotation command to the driver 40 for the motor for adjusting the position in the paper flow direction of the former. Then, if the up-button 20 is OFF in Step P7, Step P8 is executed to stop outputting of the normal rotation command to the driver 40 for the motor for adjusting the position in the paper flow direction of the former. Then, the program proceeds to Step P9. If the answer is N in Step P5, the program directly shifts to Step P9.

Then, in Step P9, it is determined whether the down-button 21 has been turned on. If the answer is Y, Step P10 is executed to output a reverse rotation command to the driver 40 for the motor for adjusting the position in the paper flow direction of the former. Then, if the down-button 21 is OFF in Step P11, Step P12 is executed to stop outputting of the reverse rotation command to the driver 40 for the motor for adjusting the position in the paper flow direction of the former. Then, the program returns to Step P4. If the answer is N in Step P9, the program directly returns to Step P4.

Then, in the aforementioned Step P13, it is determined whether the selection switch 16 for adjusting the position in the paper flow direction of the turn bar has been turned on. If the answer is Y, it is determined in Step P14 whether the position adjustment completion switch 19 is ON. If the answer is N in Step P13, the program shifts to Step P23 to be described later.

Then, if the answer is Y in Step P14, the program shifts to Step P23 to be described later. If the answer is N in Step P14, it is determined in Step P15 whether the up-button 20 is ON.

Then, if the answer is Y in Step P15, Step P16 is executed to output a normal rotation command to the driver 44 for the motor for adjusting the position in the paper flow direction of the turn bar. Then, if the up-button 20 is OFF in Step P17, Step P18 is executed to stop outputting of the normal rotation command to the driver 44 for the motor for adjusting the position in the paper flow direction of the turn bar. Then, the program proceeds to Step P19. If the answer is N in Step P15, the program directly shifts to Step P19.

Then, in Step P19, it is determined whether the down-button 21 has been turned on. If the answer is Y, Step P20 is executed to output a reverse rotation command to the driver 44 for the motor for adjusting the position in the paper flow direction of the turn bar. Then, if the down-button 21 is OFF in Step P21, Step P22 is executed to stop outputting of the reverse rotation command to the driver 44 for the motor for adjusting the position in the paper flow direction of the turn bar. Then, the program returns to Step P14. If the answer is N in Step P19, the program directly returns to Step P14.

Then, in the aforementioned Step P23, it is determined whether the selection switch 17 for adjusting the position in the lateral direction of the chopper on the former side is ON. If the answer is Y, it is determined in Step P24 whether the position adjustment completion switch 19 is ON. If the answer is N in Step P23, the program shifts to Step P33 to be described later.

Then, if the answer is Y in Step P24, the program shifts to Step P33 to be described later. If the answer is N in Step P24, it is determined in Step P25 whether the up-button 20 is ON.

Then, if the answer is Y in Step P25, Step P26 is executed to output a normal rotation command to the driver 48 for the motor for adjusting the position in the lateral direction of the chopper on the former side. Then, if the up-button 20 is OFF in Step P27, Step P28 is executed to stop outputting of the normal rotation command to the driver 48 for the motor for adjusting the position in the lateral direction of the chopper on the former side. Then, the program proceeds to Step P29. If the answer is N in Step P25, the program directly shifts to Step P29.

Then, it is determined in Step P29 whether the down-button 21 is ON. If the answer is Y, Step P30 is executed to output a reverse rotation command to the driver 48 for the motor for adjusting the position in the lateral direction of the chopper on the former side. Then, if the down-button 21 is OFF in Step P31, Step P32 is executed to stop outputting of the reverse rotation command to the driver 48 for the motor for adjusting the position in the lateral direction of the chopper on the former side. Then, the program returns to Step P24. If the answer is N in Step P29, the program directly returns to Step P24.

Then, in the aforementioned Step P33, it is determined whether the selection switch 18 for adjusting the position in the lateral direction of the chopper on the turn bar side is ON. If the answer is Y, it is determined in Step P34 whether the position adjustment completion switch 19 is ON. If the answer is N in Step P33, the program shifts to Step P43 to be described later.

Then, if the answer is Y in Step P34, the program shifts to Step P43 to be described later. If the answer is N in Step P34, it is determined in Step P35 whether the up-button 20 is ON.

Then, if the answer is Y in Step P35, Step P36 is executed to output a normal rotation command to the driver 52 for the motor for adjusting the position in the lateral direction of the chopper on the turn bar side. Then, if the up-button 20 is OFF in Step P37, Step P38 is executed to stop outputting of the normal rotation command to the driver 52 for the motor for adjusting the position in the lateral direction of the chopper on the turn bar side. Then, the program proceeds to Step P39. If the answer is N in Step P35, the program directly shifts to Step P39.

Then, it is determined in Step P39 whether the down-button 21 is ON. If the answer is Y, Step P40 is executed to output a reverse rotation command to the driver 52 for the motor for adjusting the position in the lateral direction of the chopper on the turn bar side. Then, if the down-button 21 is OFF in Step P41, Step P42 is executed to stop outputting of the reverse rotation command to the driver 52 for the motor for adjusting the position in the lateral direction of the chopper on the turn bar side. Then, the program returns to Step P34. If the answer is N in Step P39, the program directly returns to Step P34.

Then, in the aforementioned Step P43, it is determined whether the control start switch 22 is ON. If the answer is Y, the program proceeds to Step P44 to be described later. If the answer is N, the program returns to Step P1.

In accordance with the above-described motion flow, the position in the paper flow direction of the former 108, the position in the paper flow direction of the turn bar 101, the position in the lateral direction of the chopper 107b on the former side, and the position in the lateral direction of the chopper 107a on the turn bar side are initialized manually (at the push of the button) in accordance with the web width.

Then, in the aforementioned Step P44, the table of conversion from the web width to the count value of the counter for detecting the position of the detector located downstream of the former is loaded from the memory M2. Then, in Step P45, the web width is loaded from the memory M1. Then, in Step P46, the count value of the counter for detecting the position of the detector located downstream of the former in conformity with the web width is found from the web width with the use of the table of conversion from the web width to the count value of the counter for detecting the position of the detector located downstream of the former, and the count value is stored into the memory M3.

Then, in Step P47, the count value is loaded from the counter 34 for detecting the position in the lateral direction of the detector located downstream of the former, and this count value is stored into the memory M4. Then, in Step P48, it is determined whether the count value of the counter for detecting the position of the detector located downstream of the former in conformity with the web width is equal to the count value of the counter for detecting the position in the lateral direction of the detector located downstream of the former.

If the answer is Y in Step P48, the program shifts to Step P60 to be described later. If the answer is N, it is determined in Step P49 whether the count value of the counter for detecting the position of the detector located downstream of the former in conformity with the web width is greater than the count value of the counter for detecting the position in the lateral direction of the detector located downstream of the former.

If the answer is Y in Step P49, Step P50 is executed to output a normal rotation command to the driver 32 for the motor for adjusting the position in the lateral direction of the detector located downstream of the former. Then, in Step P51, the count value of the counter for detecting the position of the detector located downstream of the former in conformity with the web width is loaded from the memory M3.

Then, in Step P52, the count value is loaded from the counter 34 for detecting the position in the lateral direction of the detector located downstream of the former, and this count value is stored into the memory M4. Then, in Step P53, it is determined whether the count value of the counter for detecting the position of the detector located downstream of the former in conformity with the web width is equal to the count value of the counter for detecting the position in the lateral direction of the detector located downstream of the former.

If the answer is Y in Step P53, Step P54 is executed to stop outputting of the normal rotation command to the driver 32 for the motor for adjusting the position in the lateral direction of the detector located downstream of the former. Then, the program shifts to Step P60 to be described later. If the answer is N in Step P53, the program returns to Step P51.

If the answer is N in the aforementioned Step P49, Step P55 is executed to output a reverse rotation command to the driver 32 for the motor for adjusting the position in the lateral direction of the detector located downstream of the former. Then, in Step P56, the count value of the counter for detecting the position of the detector located downstream of the former in conformity with the web width is loaded from the memory M3.

Then, in Step P57, the count value is loaded from the counter 34 for detecting the position in the lateral direction of the detector located downstream of the former, and this count value is stored into the memory M4. Then, in Step P58, it is determined whether the count value of the counter for detecting the position of the detector located downstream of the former in conformity with the web width is equal to the count value of the counter for detecting the position in the lateral direction of the detector located downstream of the former.

If the answer is Y in the above Step P58, Step P59 is executed to stop outputting of the reverse rotation command to the driver 32 for the motor for adjusting the position in the lateral direction of the detector located downstream of the former. Then, the program shifts to Step P60 to be described later. If the answer is N in Step P58, the program returns to Step P56.

Then, in the aforementioned Step P60, the table of conversion from the web width to the count value of the counter for detecting the position of the detector located downstream of the turn bar is loaded from the memory M5. Then, in Step P61, the web width is loaded from the memory M1. Then, in Step P62, the count value of the counter for detecting the position of the detector located downstream of the turn bar in conformity with the web width is found from the web width with the use of the table of conversion from the web width to the count value of the counter for detecting the position of the detector located downstream of the turn bar, and the count value is stored into the memory M6.

Then, in Step P63, the count value is loaded from the counter 38 for detecting the position in the lateral direction of the detector located downstream of the turn bar, and this count value is stored into the memory M7. Then, in Step P64, it is determined whether the count value of the counter for detecting the position of the detector located downstream of the turn bar in conformity with the web width is equal to the count value of the counter for detecting the position in the lateral direction of the detector located downstream of the turn bar.

If the answer is Y in Step P64, the program shifts to Step P76 to be described later. If the answer is N, it is determined in Step P65 whether the count value of the counter for detecting the position of the detector located downstream of the turn bar in conformity with the web width is greater than the count value of the counter for detecting the position in the lateral direction of the detector located downstream of the turn bar.

If the answer is Y in Step P65, Step P66 is executed to output a normal rotation command to the driver 36 for the motor for adjusting the position in the lateral direction of the detector located downstream of the turn bar. Then, in Step P67, the count value of the counter for detecting the position of the detector located downstream of the turn bar in conformity with the web width is loaded from the memory M6.

Then, in Step P68, the count value is loaded from the counter 38 for detecting the position in the lateral direction of the detector located downstream of the turn bar, and this count value is stored into the memory M7. Then, in Step P69, it is determined whether the count value of the counter for detecting the position of the detector located downstream of the turn bar in conformity with the web width is equal to the count value of the counter for detecting the position in the lateral direction of the detector located downstream of the turn bar.

If the answer is Y in Step P69, Step P70 is executed to stop outputting of the normal rotation command to the driver 36 for the motor for adjusting the position in the lateral direction of the detector located downstream of the turn bar. Then, the program shifts to Step P76 to be described later. If the answer is N in Step P69, the program returns to Step P67.

If the answer is N in the aforementioned Step P65, Step P71 is executed to output a reverse rotation command to the driver 36 for the motor for adjusting the position in the lateral direction of the detector located downstream of the turn bar. Then, in Step P72, the count value of the counter for detecting the position of the detector located downstream of the turn bar in conformity with the web width is loaded from the memory M6.

Then, in Step P73, the count value is loaded from the counter 38 for detecting the position in the lateral direction of the detector located downstream of the turn bar, and this count value is stored into the memory M7. Then, in Step P74, it is determined whether the count value of the counter for detecting the position of the detector located downstream of the turn bar in conformity with the web width is equal to the count value of the counter for detecting the position in the lateral direction of the detector located downstream of the turn bar.

If the answer is Y in the above Step P74, Step P75 is executed to stop outputting of the reverse rotation command to the driver 36 for the motor for adjusting the position in the lateral direction of the detector located downstream of the turn bar. Then, the program shifts to Step P76 to be described later. If the answer is N in Step P74, the program returns to Step P72.

In accordance with the above-described motion flow, the position in the lateral direction of the detector 29 located downstream of the former, and the position in the lateral direction of the detector 31 located downstream of the turn bar are initialized automatically in accordance with the web width.

Then, in the aforementioned Step P76, the count value is loaded from the counter 42 for detecting the position in the paper flow direction of the former, and is stored into the memory M8 for storing the reference count value of the counter for detecting the position in the paper flow direction of the former. Then, in Step P77, the output of the detector 29 located downstream of the former is loaded from the A/D converter 28 connected to the detector 29 located downstream of the former, and is stored into the memory M9 for storing the reference output of the detector located downstream of the former.

Then, in the aforementioned Step P78, the count value is loaded from the counter 46 for detecting the position in the paper flow direction of the turn bar, and is stored into the memory M10 for storing the reference count value of the counter for detecting the position in the paper flow direction of the turn bar. Then, in Step P79, the output of the detector 31 located downstream of the turn bar is loaded from the A/D converter 30 connected to the detector 31 located downstream of the turn bar, and is stored into the memory M11 for storing the reference output of the detector located downstream of the turn bar.

Then, in Step P80, the output of the detector 29 located downstream of the former is loaded from the A/D converter 28 connected to the detector 29 located downstream of the former, and is stored into the memory M12. Then, in Step P81, the reference output of the detector located downstream of the former is loaded from the memory M9.

Then, in Step P82, the output of the detector located downstream of the former is subtracted from the reference output of the detector located downstream of the former to compute the output difference of the detector located downstream of the former, which is stored into the memory M13. Then, in Step P83, the table of conversion from the output difference of the detector located downstream of the former to the correction count value of the counter for detecting the position in the paper flow direction of the former is loaded from the memory M14.

Then, in Step P84, the correction count value of the counter for detecting the position in the paper flow direction of the former is found from the output difference of the detector located downstream of the former with the use of the table of conversion from the output difference of the detector located downstream of the former to the correction count value of the counter for detecting the position in the paper flow direction of the former, and this correction count value is stored into the memory M15. Then, in Step P85, the reference count value of the counter for detecting the position in the paper flow direction of the former is loaded from the memory M8.

Then, in Step P86, the correction count value of the counter for detecting the position in the paper flow direction of the former is subtracted from the reference count value of the counter for detecting the position in the paper flow direction of the former to compute the desired count value of the counter for detecting the position in the paper flow direction of the former, and this desired count value is stored into the memory M16. Then, in Step P87, the count value is loaded from the counter 42 for detecting the position in the paper flow direction of the former, and is stored into the memory M17.

Then, in Step P88, it is determined whether the desired count value of the counter for detecting the position in the paper flow direction of the former is equal to the count value of the counter for detecting the position in the paper flow direction of the former. If the answer is Y, the program shifts to Step P100 to be described later. If the answer is N, it is determined in Step P89 whether the desired count value of the counter for detecting the position in the paper flow direction of the former is greater than the count value of the counter for detecting the position in the paper flow direction of the former.

If the answer is Y in Step P89, Step P90 is executed to output a normal rotation command to the driver 40 for the motor for adjusting the position in the paper flow direction of the former. Then, in Step P91, the desired count value of the counter for detecting the position in the paper flow direction of the former is loaded from the memory M16.

Then, in Step P92, the count value is loaded from the counter 42 for detecting the position in the paper flow direction of the former, and is stored into the memory M17. Then, in Step P93, it is determined whether the desired count value of the counter for detecting the position in the paper flow direction of the former is equal to the count value of the counter for detecting the position in the paper flow direction of the former.

If the answer is Y in Step P93, Step P94 is executed to stop outputting of the normal rotation command to the driver 40 for the motor for adjusting the position in the paper flow direction of the former. Then, the program shifts to Step P100 to be described later. If the answer is N in Step P93, the program returns to Step P91.

If the answer is N in Step P89, Step P95 is executed to output a reverse rotation command to the driver 40 for the motor for adjusting the position in the paper flow direction of the former. Then, in Step P96, the desired count value of the counter for detecting the position in the paper flow direction of the former is loaded from the memory M16.

Then, in Step P97, the count value is loaded from the counter 42 for detecting the position in the paper flow direction of the former, and is stored into the memory M17. Then, in Step P98, it is determined whether the desired count value of the counter for detecting the position in the paper flow direction of the former is equal to the count value of the counter for detecting the position in the paper flow direction of the former.

Then, if the answer is Y in Step P98, Step P99 is executed to stop outputting of the reverse rotation command to the driver 40 for the motor for adjusting the position in the paper flow direction of the former. Then, the program shifts to Step P100 to be described later. If the answer is N in Step P98, the program returns to Step P96.

In accordance with the above-described motion flow, the position in the paper flow direction of the former 108 is feedback-controlled responsive to the detection signal from the detector 29 located downstream of the former.

Then, in the aforementioned Step P100, the output of the detector 31 located downstream of the turn bar is loaded from the A/D converter 30 connected to the detector 31 located downstream of the turn bar, and is stored into the memory M18. Then, in Step P101, the reference output of the detector located downstream of the turn bar is loaded from the memory M11.

Then, in Step P102, the output of the detector located downstream of the turn bar is subtracted from the reference output of the detector located downstream of the turn bar to compute the output difference of the detector located downstream of the turn bar, which is stored into the memory M19. Then, in Step P103, the table of conversion from the output difference of the detector located downstream of the turn bar to the correction count value of the counter for detecting the position in the paper flow direction of the turn bar is loaded from the memory M20.

Then, in Step P104, the correction count value of the counter for detecting the position in the paper flow direction of the turn bar is found from the output difference of the detector located downstream of the turn bar with the use of the table of conversion from the output difference of the detector located downstream of the turn bar to the correction count value of the counter for detecting the position in the paper flow direction of the turn bar, and this correction count value is stored into the memory M21. Then, in Step P105, the reference count value of the counter for detecting the position in the paper flow direction of the turn bar is loaded from the memory M10.

Then, in Step P106, the correction count value of the counter for detecting the position in the paper flow direction of the turn bar is subtracted from the reference count value of the counter for detecting the position in the paper flow direction of the turn bar to compute the desired count value of the counter for detecting the position in the paper flow direction of the turn bar, and this desired count value is stored into the memory M22. Then, in Step P107, the count value is loaded from the counter 46 for detecting the position in the paper flow direction of the turn bar, and is stored into the memory M23.

Then, in Step P108, it is determined whether the desired count value of the counter for detecting the position in the paper flow direction of the turn bar is equal to the count value of the counter for detecting the position in the paper flow direction of the turn bar. If the answer is Y, the program shifts to Step P120 to be described later. If the answer is N, it is determined in Step P109 whether the desired count value of the counter for detecting the position in the paper flow direction of the turn bar is greater than the count value of the counter for detecting the position in the paper flow direction of the turn bar.

If the answer is Y in Step P109, Step P110 is executed to output a normal rotation command to the driver 44 for the motor for adjusting the position in the paper flow direction of the turn bar. Then, in Step P111, the desired count value of the counter for detecting the position in the paper flow direction of the turn bar is loaded from the memory M22.

Then, in Step P112, the count value is loaded from the counter 46 for detecting the position in the paper flow direction of the turn bar, and is stored into the memory M23. Then, in Step P113, it is determined whether the desired count value of the counter for detecting the position in the paper flow direction of the turn bar is equal to the count value of the counter for detecting the position in the paper flow direction of the turn bar.

If the answer is Y in Step P113, Step P114 is executed to stop outputting of the normal rotation command to the driver 44 for the motor for adjusting the position in the paper flow direction of the turn bar. Then, the program shifts to Step P120 to be described later. If the answer is N in Step P113, the program returns to Step P111.

If the answer is N in the above Step P109, Step P115 is executed to output a reverse rotation command to the driver 44 for the motor for adjusting the position in the paper flow direction of the turn bar. Then, in Step P116, the desired count value of the counter for detecting the position in the paper flow direction of the turn bar is loaded from the memory M22.

Then, in Step P117, the count value is loaded from the counter 46 for detecting the position in the paper flow direction of the turn bar, and is stored into the memory M23. Then, in Step P118, it is determined whether the desired count value of the counter for detecting the position in the paper flow direction of the turn bar is equal to the count value of the counter for detecting the position in the paper flow direction of the turn bar.

Then, if the answer is Y in the above Step P118, Step P119 is executed to stop outputting of the reverse rotation command to the driver 44 for the motor for adjusting the position in the paper flow direction of the turn bar. Then, the program shifts to Step P120 to be described later. If the answer is N in Step P118, the program returns to Step P116.

Then, in the aforementioned Step P120, it is determined whether the control stop switch 23 is ON. If the answer is Y, the control motion or action is terminated. If the answer is N, the program returns to Step P80. Afterwards, this procedure is repeated.

In accordance with the above-described motion flow, the position in the paper flow direction of the turn bar 101 is feedback-controlled responsive to the detection signal from the detector 31 located downstream of the turn bar.

In the present embodiment, as described above, the positions in the paper flow direction of the former 108 and the turn bar 101 are automatically adjusted in response to detection signals from the detector 29 located downstream of the former and the detector 31 located downstream of the turn bar.

Thus, the air blowing amount of the former 108 or the turn bar 101 changes according to a change in the state of the printing press, such as the rotational speed of the web rotary printing press, whereby bulging of the web Wb or Wa changes. Even if the position of the signature Sb1 or Sa1 transported to the chopper 107b or 107a of the folding machine changes on each such occasion, the position in the paper flow direction of the former 108 or the turn bar 101 is automatically adjusted accordingly. As a result, the position of the signature Sb1 or Sa1 transported to the chopper 107b or 107a of the folding machine becomes always constant.

Consequently, a manual operation by the operator is not required, so that the burden on the operator is lessened, and the rate of operation is increased by automation. Furthermore, a response for position adjustment also quickens to decrease the occurrence of wasted paper and curb its increase.

The present embodiment illustrates the web rotary printing press in which the webs Wa, Wb are transported, respectively, to the choppers 107a, 107b of the folding machine via the turn bar 101 and the former 108. Needless to say, however, the present invention can be applied to a web rotary printing press having the turn bar or turn bars 101 in one path or two paths, or the former or formers 108 in one path or two paths.

### Embodiment 2

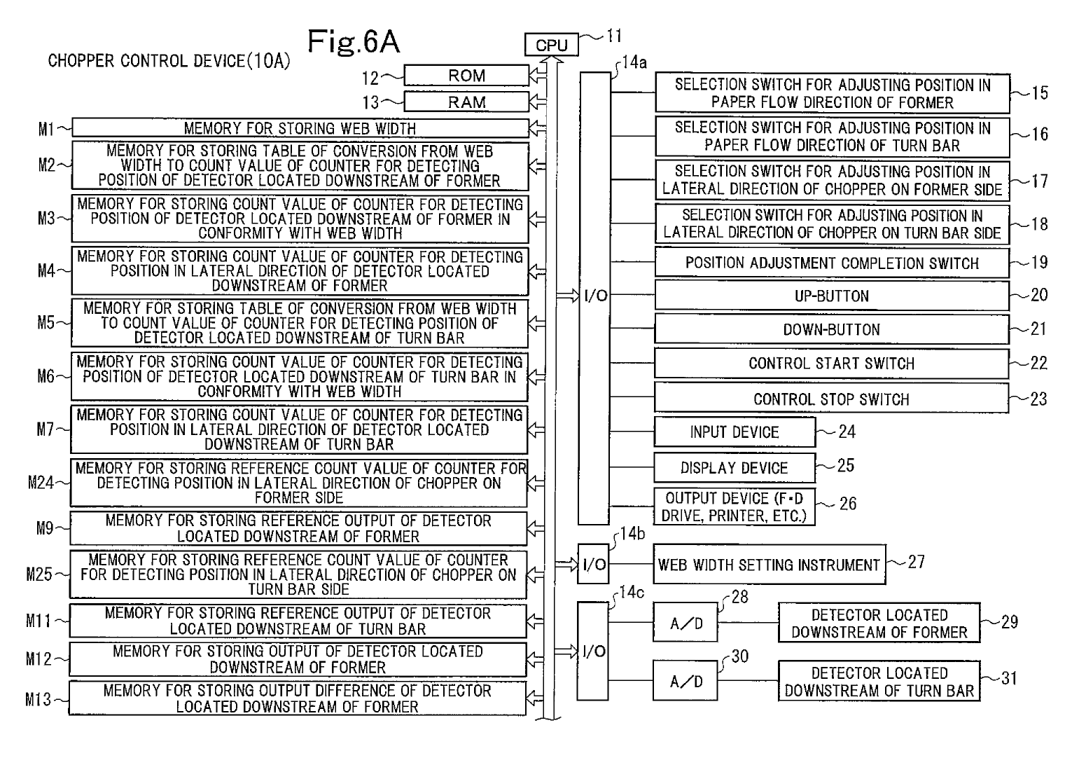

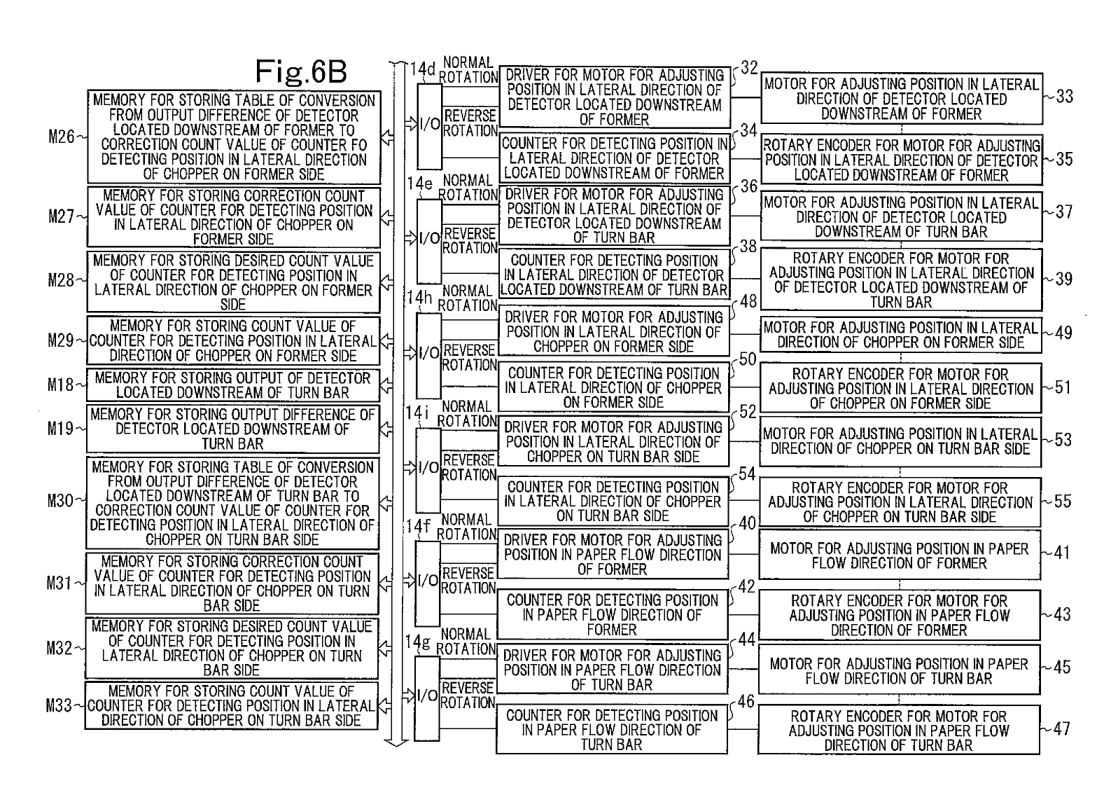

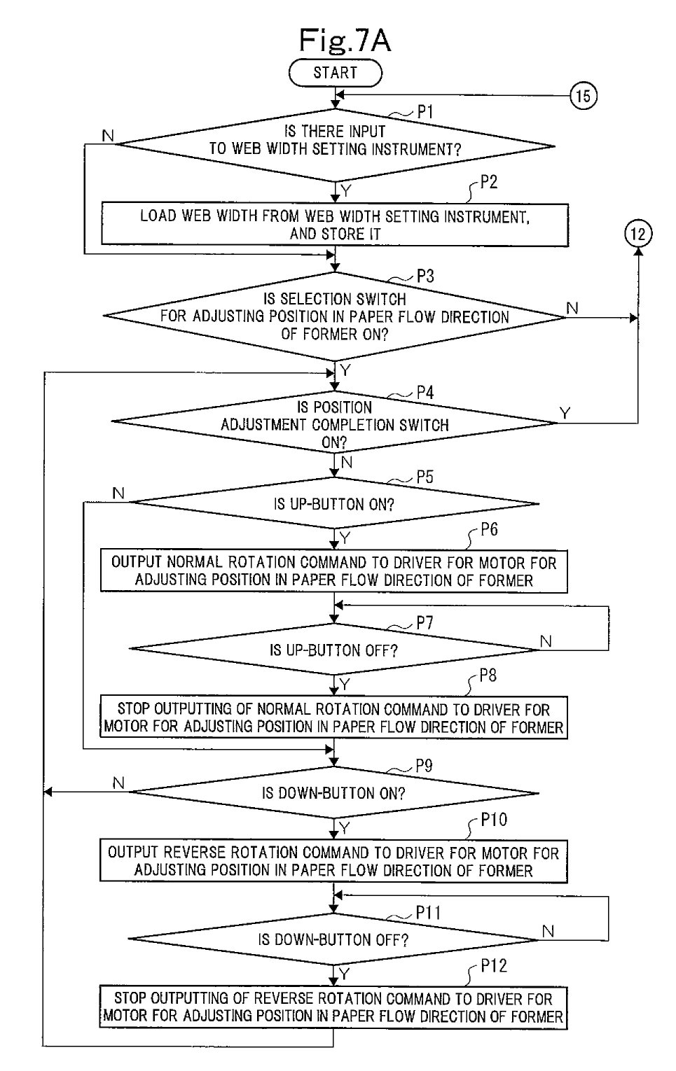

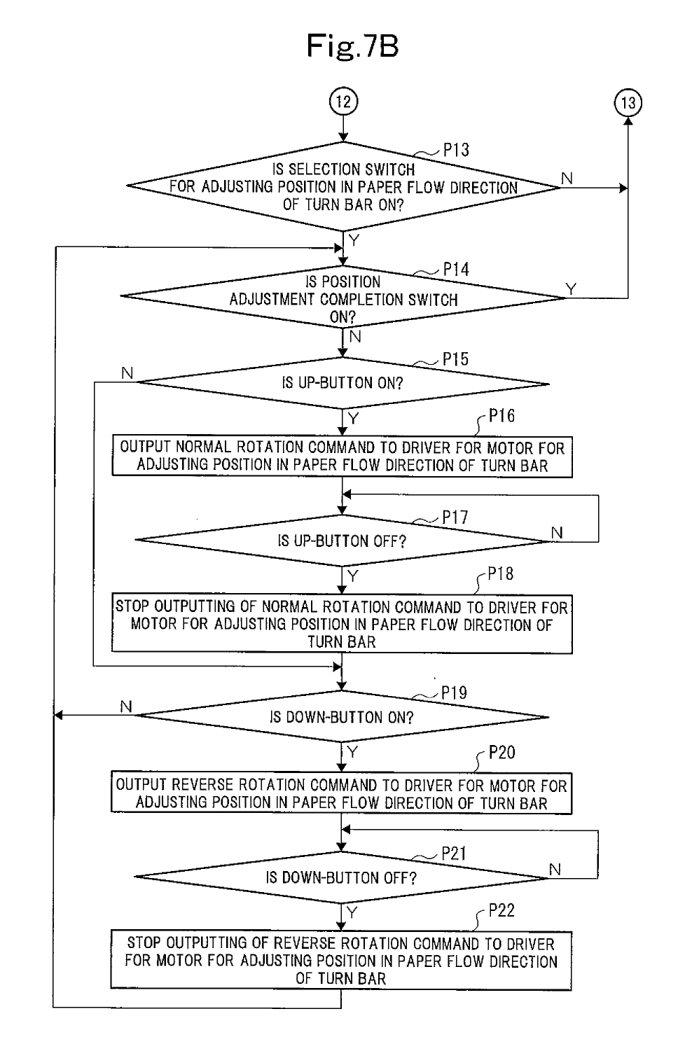

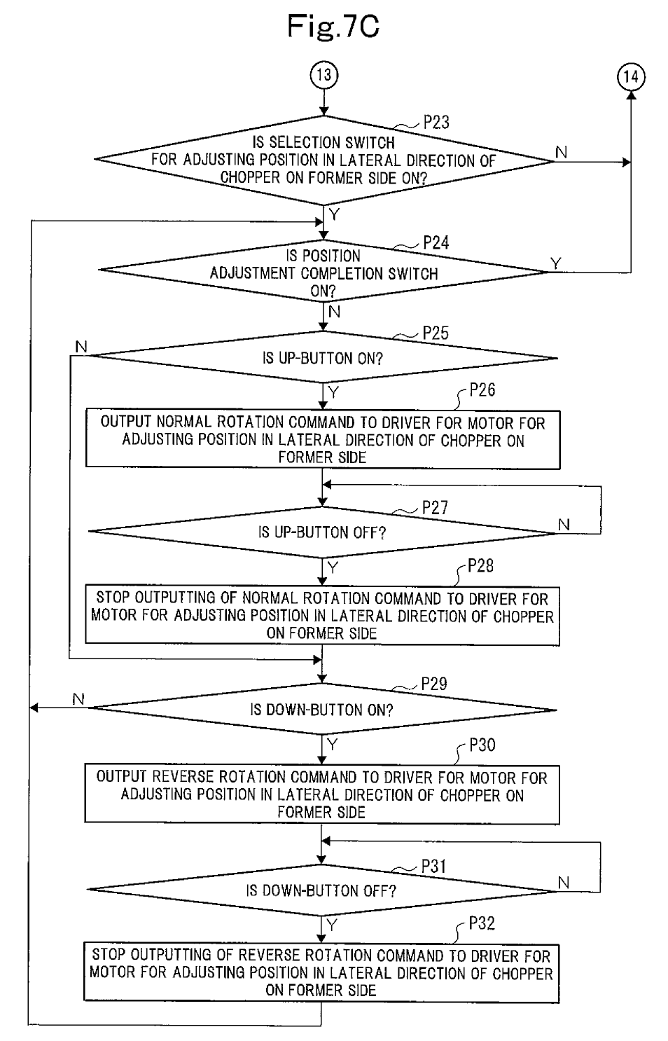

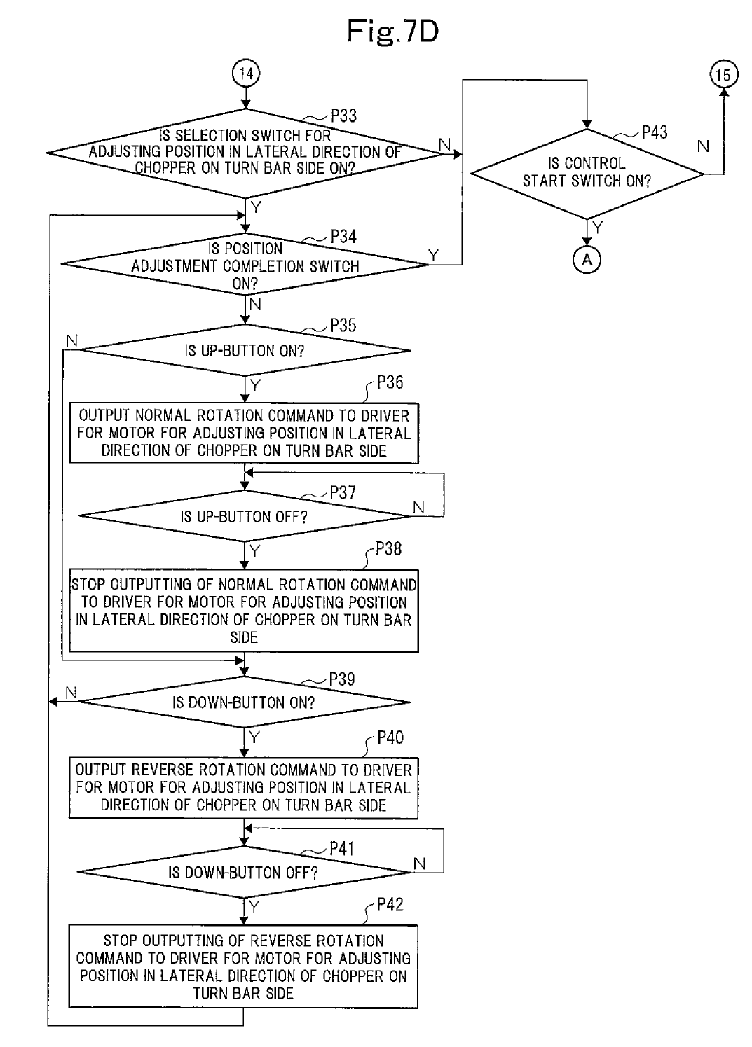

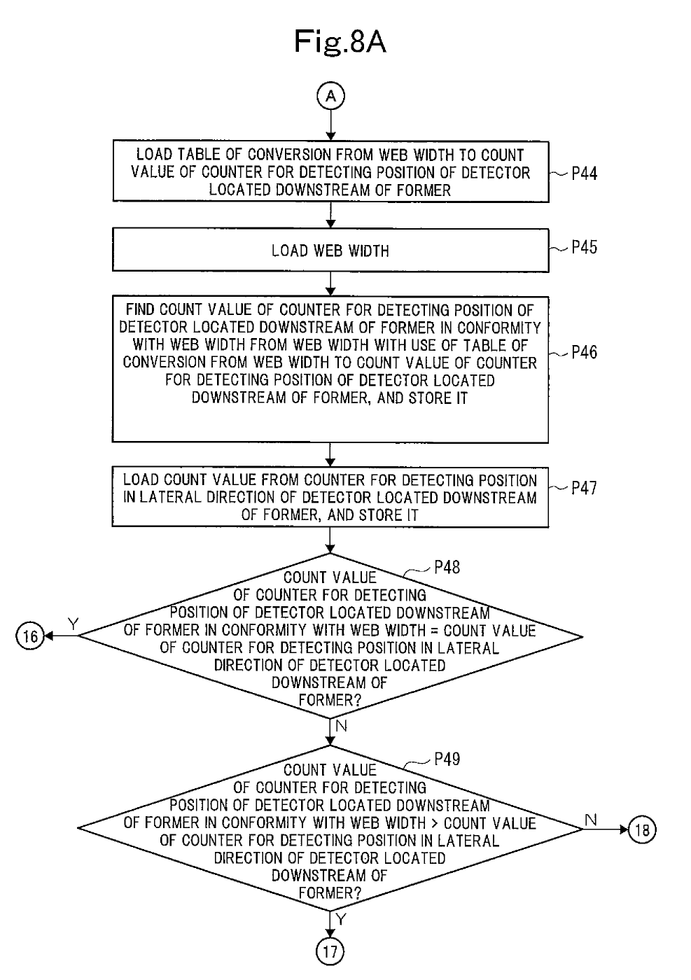

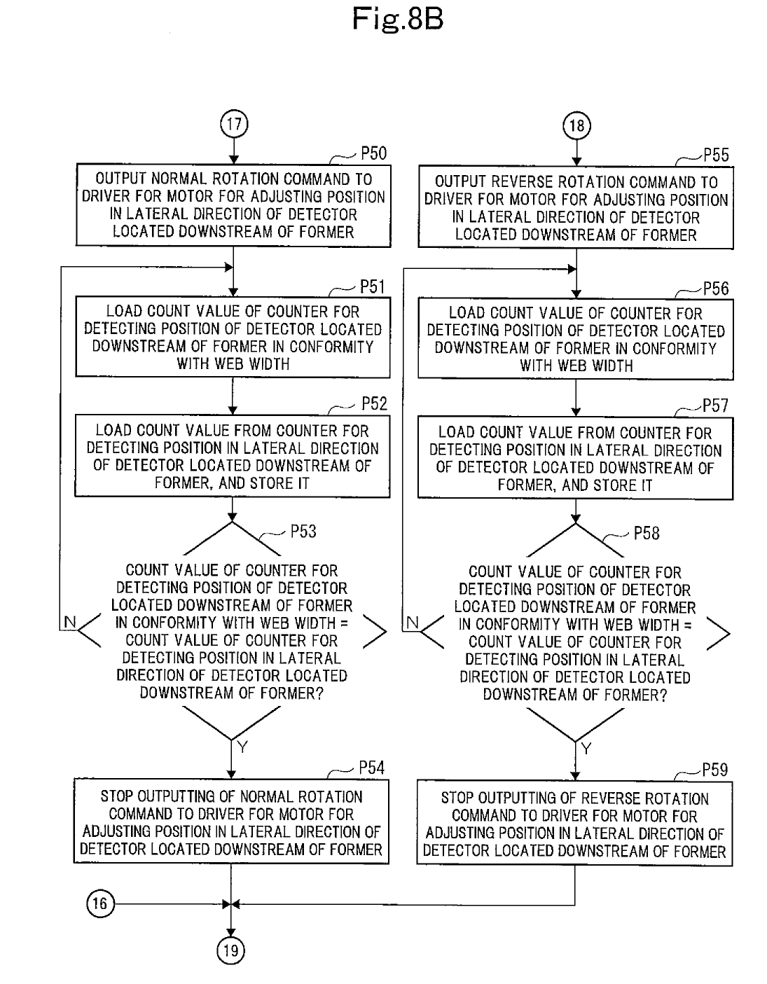

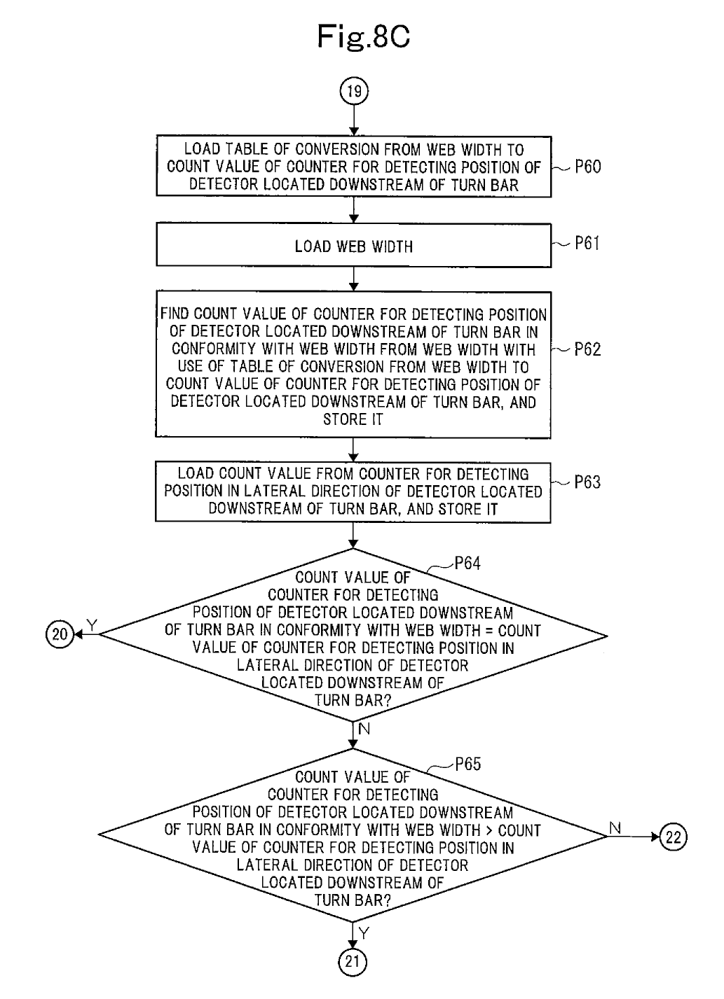

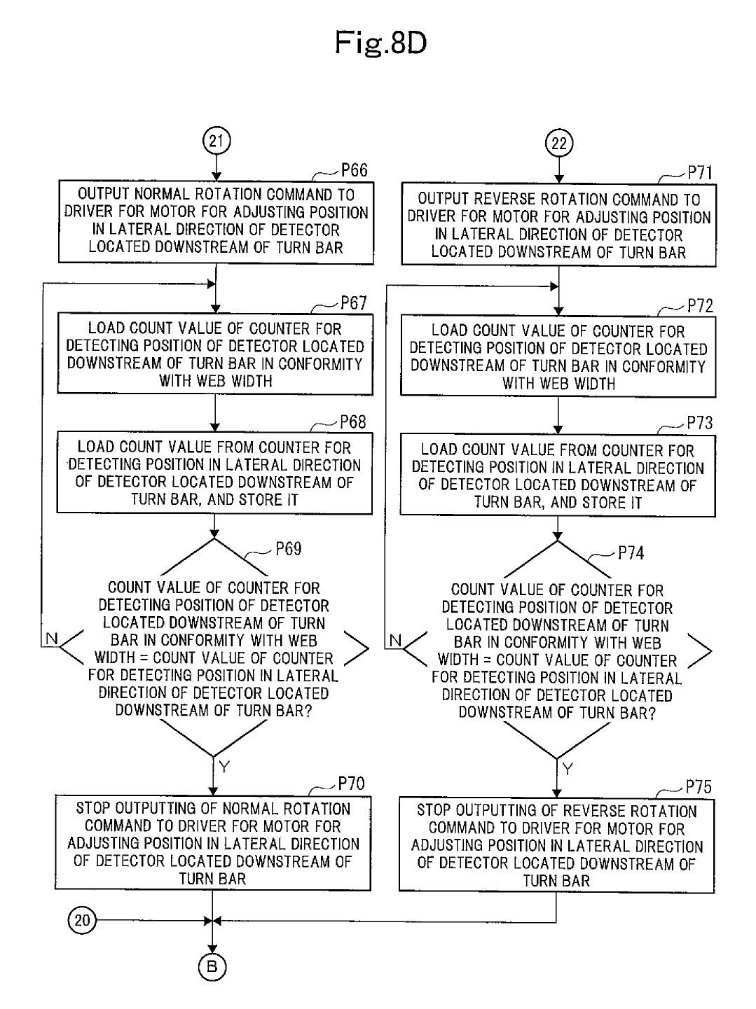

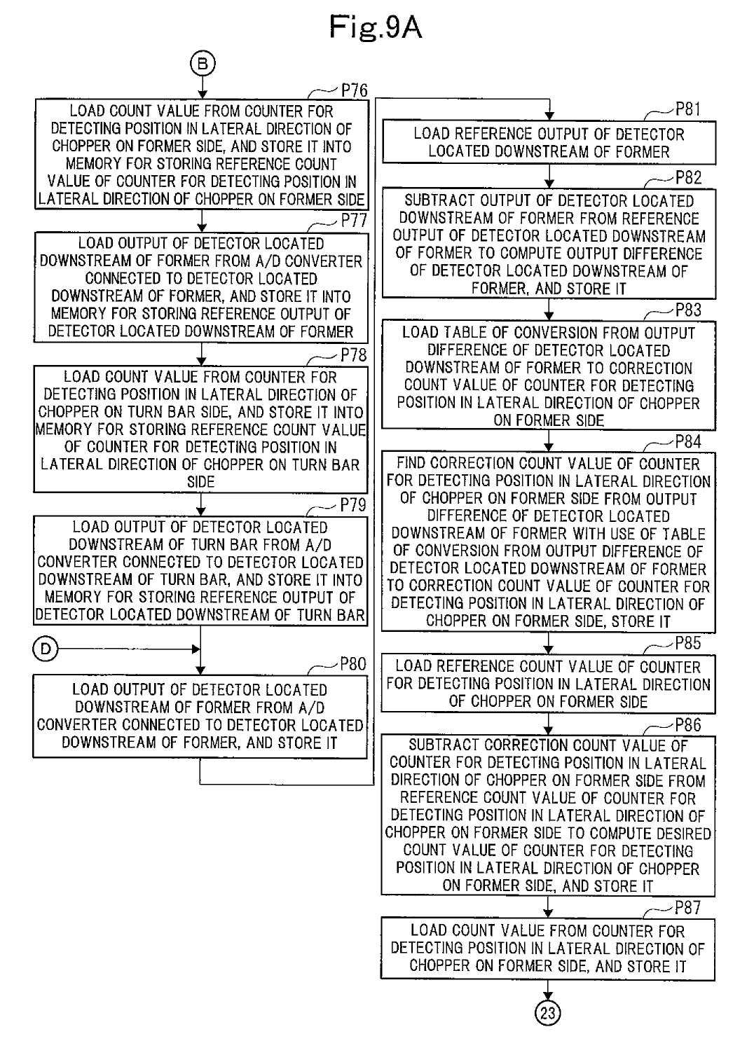

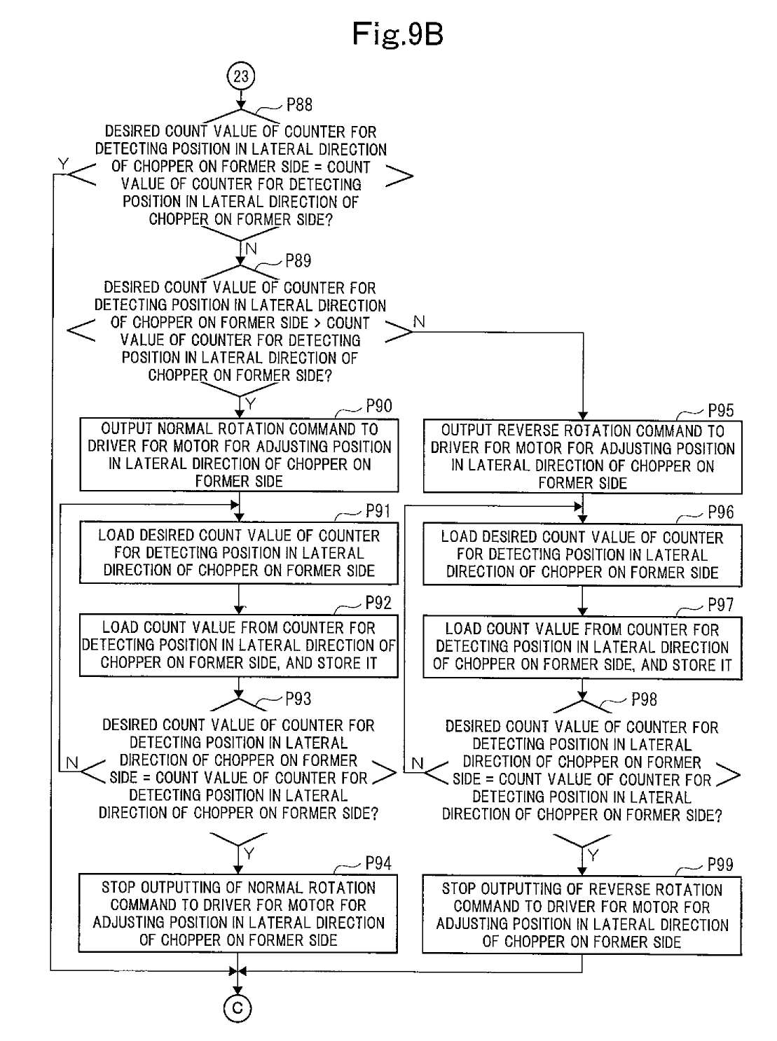

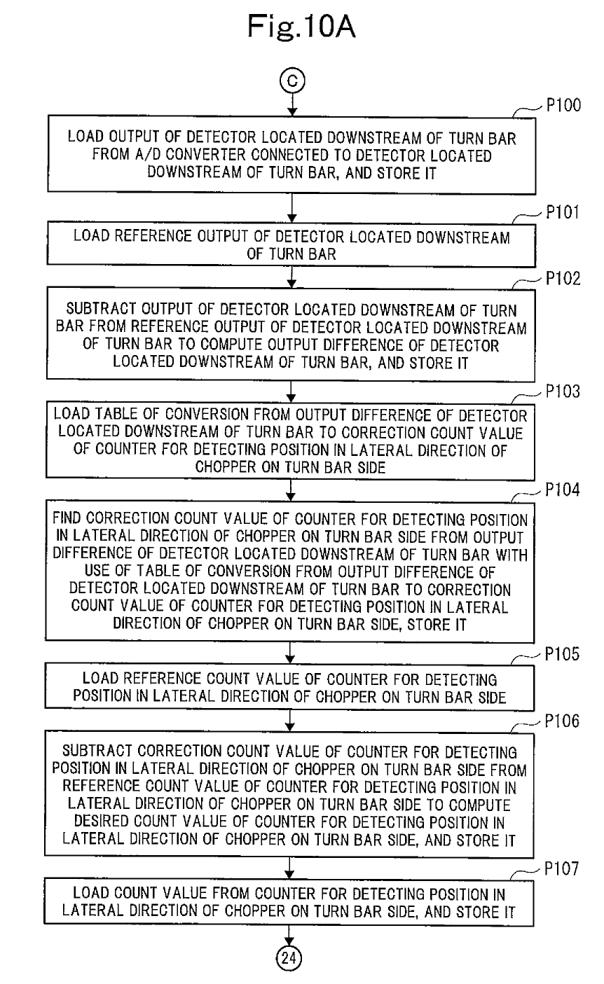

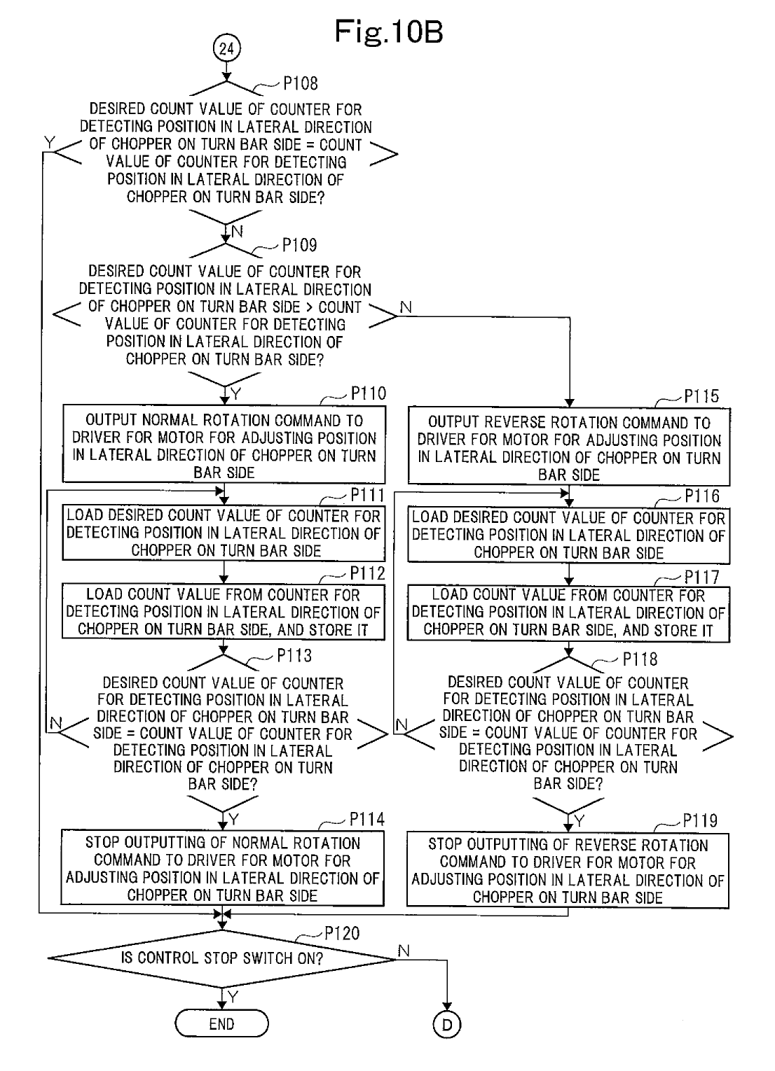

FIGS. 6A and 6B are block diagrams of a chopper control device showing Embodiment 2 of the present invention. FIGS. 7A to 7D are motion flow charts of the chopper control device. FIGS. 8A to 8D are motion flow charts of the chopper control device. FIGS. 9A and 9B are motion flow charts of the chopper control device. FIGS. 10A and 10B are motion flow charts of the chopper control device.

The present embodiment corresponds to Embodiment 1, except that the positions in the lateral direction (the positions in a direction orthogonal to the signature transport direction) of the chopper (chopper folding device) 107b on the former side and the chopper (chopper folding device) 107a on the turn bar side are automatically adjusted in response to detection signals from the detector 29 located downstream of the former and the detector 31 located downstream of the turn bar, instead of the positions in the paper flow direction of the former 108 and the turn bar 101 being automatically adjusted in response to detection signals from the detector 29 located downstream of the former and the detector 31 located downstream of the turn bar. The configuration of the web rotary printing press (strip-shaped material printing press) is the same as that in FIGS. 11 to 16. Thus, duplicate descriptions are omitted by reference to descriptions of this configuration.

That is, a chopper control device 10A comprises CPU 11, ROM 12, RAM 13, and input/output devices 14a to 14i connected together by BUS (bus line), as shown in FIGS. 6A and 6B.

To the BUS (bus line), the following memories are connected: A memory M1 for storing the web width, a memory M2 for storing a table of conversion from the web width to the count value of a counter for detecting the position of the detector located downstream of the former, a memory M3 for storing the count value of the counter for detecting the position of the detector located downstream of the former in conformity with the web width, a memory M4 for storing the count value of a counter for detecting the position in the lateral direction of the detector located downstream of the former, a memory M5 for storing a table of conversion from the web width to the count value of a counter for detecting the position of the detector located downstream of the turn bar, a memory M6 for storing the count value of the counter for detecting the position of the detector located downstream of the turn bar in conformity with the web width, a memory M7 for storing the count value of a counter for detecting the position in the lateral direction of the detector located downstream of the turn bar, a memory M24 for storing the reference count value of a counter for detecting the position in the lateral direction of the chopper on the former side, a memory M9 for storing the reference output of the detector located downstream of the former, a memory M25 for storing the reference count value of a counter for detecting the position in the lateral direction of the chopper on the turn bar side, and a memory M11 for storing the reference output of the detector located downstream of the turn bar.

To the BUS (bus line), the following memories are further connected: A memory M12 for storing the output of the detector located downstream of the former, a memory M13 for storing the output difference of the detector located downstream of the former, a memory M26 for storing a table of conversion from the output difference of the detector located downstream of the former to the correction count value of the counter for detecting the position in the lateral direction of the chopper on the former side, a memory M27 for storing the correction count value of the counter for detecting the position in the lateral direction of the chopper on the former side, a memory M28 for storing the desired count value of the counter for detecting the position in the lateral direction of the chopper on the former side, a memory M29 for storing the count value of the counter for detecting the position in the lateral direction of the chopper on the former side, a memory M18 for storing the output of the detector located downstream of the turn bar, a memory M19 for storing the output difference of the detector located downstream of the turn bar, a memory M30 for storing a table of conversion from the output difference of the detector located downstream of the turn bar to the correction count value of the counter for detecting the position in the lateral direction of the chopper on the turn bar side, a memory M31 for storing the correction count value of the counter for detecting the position in the lateral direction of the chopper on the turn bar side, a memory M32 for storing the desired count value of the counter for detecting the position in the lateral direction of the chopper on the turn bar side, and a memory M33 for storing the count value of the counter for detecting the position in the lateral direction of the chopper on the turn bar side.

To the input/output device 14a, the following are connected: A selection switch 15 for adjusting the position in the paper flow direction of the former, a selection switch 16 for adjusting the position in the paper flow direction of the turn bar, a selection switch 17 for adjusting the position in the lateral direction of the chopper on the former side, a selection switch 18 for adjusting the position in the lateral direction of the chopper on the turn bar side, a position adjustment completion switch 19, an up-button 20, a down-button 21, a control start switch 22, a control stop switch 23, an input device 24 such as a keyboard, a display device 25 such as CRT and display, and an output device 26 such as a printer and a floppy disk (registered trademark) drive.

To the input/output device 14b, a web width setting instrument 27 is connected.

To the input/output device 14c, the detector 29 located downstream of the former is connected via an A/D converter 28, and the detector 31 located downstream of the turn bar is connected via an A/D converter 30.

To the input/output device 14d, the motor 33 for adjusting the position in the lateral direction of the detector located downstream of the former is connected via a driver 32 for the motor for adjusting the position in the lateral direction of the detector located downstream of the former, and a rotary encoder 35 for the motor for adjusting the position in the lateral direction of the detector located downstream of the former is connected via a counter 34 for detecting the position in the lateral direction of the detector located downstream of the former.

To the input/output device 14e, the motor 37 for adjusting the position in the lateral direction of the detector located downstream of the turn bar is connected via a driver 36 for the motor for adjusting the position in the lateral direction of the detector located downstream of the turn bar, and a rotary encoder 39 for the motor for adjusting the position in the lateral direction of the detector located downstream of the turn bar is connected via a counter 38 for detecting the position in the lateral direction of the detector located downstream of the turn bar.

To the input/output device 14f, the motor 41 for adjusting the position in the paper flow direction of the former is connected via a driver 40 for the motor for adjusting the position in the paper flow direction of the former, and a rotary encoder 43 for the motor for adjusting the position in the paper flow direction of the former is connected via a counter 42 for detecting the position in the paper flow direction of the former.

To the input/output device 14g, the motor 45 for adjusting the position in the paper flow direction of the turn bar is connected via a driver 44 for the motor for adjusting the position in the paper flow direction of the turn bar, and a rotary encoder 47 for the motor for adjusting the position in the paper flow direction of the turn bar is connected via a counter 46 for detecting the position in the paper flow direction of the turn bar.

To the input/output device 14h, the motor 49 for adjusting the position in the lateral direction of the chopper on the former side is connected via a driver 48 for the motor for adjusting the position in the lateral direction of the chopper on the former side, and a rotary encoder 51 for the motor for adjusting the position in the lateral direction of the chopper on the former side is connected via a counter 50 for detecting the position in the lateral direction of the chopper on the former side.

To the input/output device 14i, the motor 53 for adjusting the position in the lateral direction of the chopper on the turn bar side is connected via a driver 52 for the motor for adjusting the position in the lateral direction of the chopper on the turn bar side, and a rotary encoder 55 for the motor for adjusting the position in the lateral direction of the chopper on the turn bar side is connected via a counter 54 for detecting the position in the lateral direction of the chopper on the turn bar side.

The control actions or motions of the chopper control device 10A of the above configuration will be described in detail in accordance with the motion flow charts of FIGS. 7A to 7D, 8A to 8D, 9A and 9B, and 10A and 10B.

In Step P1, it is determined whether there is an input to the web width setting instrument 27. If the answer is Y (yes), the web width is loaded from the web width setting instrument 27, and stored into the memory M1, in Step P2. Then, the program proceeds to Step P3. If the answer is N (no), the program directly shifts to Step P3.

Then, in Step P3, it is determined whether the selection switch 15 for adjusting the position in the paper flow direction of the former has been turned on. If the answer is Y, it is determined in Step P4 whether the position adjustment completion switch 19 has been turned on. If the answer is N in Step P3, the program shifts to Step P13 to be described later.

If the answer is Y in Step P4, the program shifts to Step P13 to be described later. If the answer is N in Step P4, it is determined in Step P5 whether the up-button 20 has been turned on.

If the answer is Y in Step P5, Step P6 is executed to output a normal rotation command to the driver 40 for the motor for adjusting the position in the paper flow direction of the former. Then, if the up-button 20 is OFF in Step P7, Step P8 is executed to stop outputting of the normal rotation command to the driver 40 for the motor for adjusting the position in the paper flow direction of the former. Then, the program proceeds to Step P9. If the answer is N in Step P5, the program directly shifts to Step P9.

Then, in Step P9, it is determined whether the down-button 21 has been turned on. If the answer is Y, Step P10 is executed to output a reverse rotation command to the driver 40 for the motor for adjusting the position in the paper flow direction of the former. Then, if the down-button 21 is OFF in Step P11, Step P12 is executed to stop outputting of the reverse rotation command to the driver 40 for the motor for adjusting the position in the paper flow direction of the former. Then, the program returns to Step P4. If the answer is N in Step P9, the program directly returns to Step P4.

Then, in the aforementioned Step P13, it is determined whether the selection switch 16 for adjusting the position in the paper flow direction of the turn bar has been turned on. If the answer is Y, it is determined in Step P14 whether the position adjustment completion switch 19 is ON. If the answer is N in Step P13, the program shifts to Step P23 to be described later.

Then, if the answer is Y in Step P14, the program shifts to Step P23 to be described later. If the answer is N in Step P14, it is determined in Step P15 whether the up-button 20 is ON.

Then, if the answer is Y in Step P15, Step P16 is executed to output a normal rotation command to the driver 44 for the motor for adjusting the position in the paper flow direction of the turn bar. Then, if the up-button 20 is OFF in Step P17, Step P18 is executed to stop outputting of the normal rotation command to the driver 44 for the motor for adjusting the position in the paper flow direction of the turn bar. Then, the program proceeds to Step P19. If the answer is N in Step P15, the program directly shifts to Step P19.

Then, in Step P19, it is determined whether the down-button 21 has been turned on. If the answer is Y, Step P20 is executed to output a reverse rotation command to the driver 44 for the motor for adjusting the position in the paper flow direction of the turn bar. Then, if the down-button 21 is OFF in Step P21, Step P22 is executed to stop outputting of the reverse rotation command to the driver 44 for the motor for adjusting the position in the paper flow direction of the turn bar. Then, the program returns to Step P14. If the answer is N in Step P19, the program directly returns to Step P14.

Then, in the aforementioned Step P23, it is determined whether the selection switch 17 for adjusting the position in the lateral direction of the chopper on the former side is ON. If the answer is Y, it is determined in Step P24 whether the position adjustment completion switch 19 is ON. If the answer is N in Step P23, the program shifts to Step P33 to be described later.

Then, if the answer is Y in Step P24, the program shifts to Step P33 to be described later. If the answer is N in Step P24, it is determined in Step P25 whether the up-button 20 is ON.

Then, if the answer is Y in Step P25, Step P26 is executed to output a normal rotation command to the driver 48 for the motor for adjusting the position in the lateral direction of the chopper on the former side. Then, if the up-button 20 is OFF in Step P27, Step P28 is executed to stop outputting of the normal rotation command to the driver 48 for the motor for adjusting the position in the lateral direction of the chopper on the former side. Then, the program proceeds to Step P29. If the answer is N in Step P25, the program directly shifts to Step P29.

Then, it is determined in Step P29 whether the down-button 21 is ON. If the answer is Y, Step P30 is executed to output a reverse rotation command to the driver 48 for the motor for adjusting the position in the lateral direction of the chopper on the former side. Then, if the down-button 21 is OFF in Step P31, Step P32 is executed to stop outputting of the reverse rotation command to the driver 48 for the motor for adjusting the position in the lateral direction of the chopper on the former side. Then, the program returns to Step P24. If the answer is N in Step P29, the program directly returns to Step P24.

Then, in the aforementioned Step P33, it is determined whether the selection switch 18 for adjusting the position in the lateral direction of the chopper on the turn bar side is ON. If the answer is Y, it is determined in Step P34 whether the position adjustment completion switch 19 is ON. If the answer is N in Step P33, the program shifts to Step P43 to be described later.

Then, if the answer is Y in Step P34, the program shifts to Step P43 to be described later. If the answer is N in Step P34, it is determined in Step P35 whether the up-button 20 is ON.

Then, if the answer is Y in Step P35, Step P36 is executed to output a normal rotation command to the driver 52 for the motor for adjusting the position in the lateral direction of the chopper on the turn bar side. Then, if the up-button 20 is OFF in Step P37, Step P38 is executed to stop outputting of the normal rotation command to the driver 52 for the motor for adjusting the position in the lateral direction of the chopper on the turn bar side. Then, the program proceeds to Step P39. If the answer is N in Step P35, the program directly shifts to Step P39.

Then, it is determined in Step P39 whether the down-button 21 is ON. If the answer is Y, Step P40 is executed to output a reverse rotation command to the driver 52 for the motor for adjusting the position in the lateral direction of the chopper on the turn bar side. Then, if the down-button 21 is OFF in Step P41, Step P42 is executed to stop outputting of the reverse rotation command to the driver 52 for the motor for adjusting the position in the lateral direction of the chopper on the turn bar side. Then, the program returns to Step P34. If the answer is N in Step P39, the program directly returns to Step P34.

Then, in the aforementioned Step P43, it is determined whether the control start switch 22 is ON. If the answer is Y, the program proceeds to Step P44 to be described later. If the answer is N, the program returns to Step P1.

In accordance with the above-described motion flow, the position in the paper flow-direction of the former 108, the position in the paper flow direction of the turn bar 101, the position in the lateral direction of the chopper 107b on the former side, and the position in the lateral direction of the chopper 107a on the turn bar side are initialized manually (at the push of the button) in accordance with the web width.

Then, in the aforementioned Step P44, the table of conversion from the web width to the count value of the counter for detecting the position of the detector located downstream of the former is loaded from the memory M2. Then, in Step P45, the web width is loaded from the memory M1. Then, in Step P46, the count value of the counter for detecting the position of the detector located downstream of the former in conformity with the web width is found from the web width with the use of the table of conversion from the web width to the count value of the counter for detecting the position of the detector located downstream of the former, and the count value is stored into the memory M3.

Then, in Step P47, the count value is loaded from the counter 34 for detecting the position in the lateral direction of the detector located downstream of the former, and this count value is stored into the memory M4. Then, in Step P48, it is determined whether the count value of the counter for detecting the position of the detector located downstream of the former in conformity with the web width is equal to the count value of the counter for detecting the position in the lateral direction of the detector located downstream of the former.

If the answer is Y in Step P48, the program shifts to Step P60 to be described later. If the answer is N, it is determined in Step P49 whether the count value of the counter for detecting the position of the detector located downstream of the former in conformity with the web width is greater than the count value of the counter for detecting the position in the lateral direction of the detector located downstream of the former.

If the answer is Y in Step P49, Step P50 is executed to output a normal rotation command to the driver 32 for the motor for adjusting the position in the lateral direction of the detector located downstream of the former. Then, in Step P51, the count value of the counter for detecting the position of the detector located downstream of the former in conformity with the web width is loaded from the memory M3.

Then, in Step P52, the count value is loaded from the counter 34 for detecting the position in the lateral direction of the detector located downstream of the former, and this count value is stored into the memory M4. Then, in Step P53, it is determined whether the count value of the counter for detecting the position of the detector located downstream of the former in conformity with the web width is equal to the count value of the counter for detecting the position in the lateral direction of the detector located downstream of the former.

If the answer is Y in Step P53, Step P54 is executed to stop outputting of the normal rotation command to the driver 32 for the motor for adjusting the position in the lateral direction of the detector located downstream of the former. Then, the program shifts to Step P60 to be described later. If the answer is N in Step P53, the program returns to Step P51.

If the answer is N in the aforementioned Step P49, Step P55 is executed to output a reverse rotation command to the driver 32 for the motor for adjusting the position in the lateral direction of the detector located downstream of the former. Then, in Step P56, the count value of the counter for detecting the position of the detector located downstream of the former in conformity with the web width is loaded from the memory M3.

Then, in Step P57, the count value is loaded from the counter 34 for detecting the position in the lateral direction of the detector located downstream of the former, and this count value is stored into the memory M4. Then, in Step P58, it is determined whether the count value of the counter for detecting the position of the detector located downstream of the former in conformity with the web width is equal to the count value of the counter for detecting the position in the lateral direction of the detector located downstream of the former.

If the answer is Y in the above Step P58, Step P59 is executed to stop outputting of the reverse rotation command to the driver 32 for the motor for adjusting the position in the lateral direction of the detector located downstream of the former. Then, the program shifts to Step P60 to be described later. If the answer is N in Step P58, the program returns to Step P56.

Then, in the aforementioned Step P60, the table of conversion from the web width to the count value of the counter for detecting the position of the detector located downstream of the turn bar is loaded from the memory M5. Then, in Step P61, the web width is loaded from the memory M1. Then, in Step P62, the count value of the counter for detecting the position of the detector located downstream of the turn bar in conformity with the web width is found from the web width with the use of the table of conversion from the web width to the count value of the counter for detecting the position of the detector located downstream of the turn bar, and the count value is stored into the memory M6.

Then, in Step P63, the count value is loaded from the counter 38 for detecting the position in the lateral direction of the detector located downstream of the turn bar, and this count value is stored into the memory M7. Then, in Step P64, it is determined whether the count value of the counter for detecting the position of the detector located downstream of the turn bar in conformity with the web width is equal to the count value of the counter for detecting the position in the lateral direction of the detector located downstream of the turn bar.

If the answer is Y in Step P64, the program shifts to Step P76 to be described later. If the answer is N, it is determined in Step P65 whether the count value of the counter for detecting the position of the detector located downstream of the turn bar in conformity with the web width is greater than the count value of the counter for detecting the position in the lateral direction of the detector located downstream of the turn bar.

If the answer is Y in Step P65, Step P66 is executed to output a normal rotation command to the driver 36 for the motor for adjusting the position in the lateral direction of the detector located downstream of the turn bar. Then, in Step P67, the count value of the counter for detecting the position of the detector located downstream of the turn bar in conformity with the web width is loaded from the memory M6.

Then, in Step P68, the count value is loaded from the counter 38 for detecting the position in the lateral direction of the detector located downstream of the turn bar, and this count value is stored into the memory M7. Then, in Step P69, it is determined whether the count value of the counter for detecting the position of the detector located downstream of the turn bar in conformity with the web width is equal to the count value of the counter for detecting the position in the lateral direction of the detector located downstream of the turn bar.

If the answer is Y in Step P69, Step P70 is executed to stop outputting of the normal rotation command to the driver 36 for the motor for adjusting the position in the lateral direction of the detector located downstream of the turn bar. Then, the program shifts to Step P76 to be described later. If the answer is N in Step P69, the program returns to Step P67.

If the answer is N in the aforementioned Step P65, Step P71 is executed to output a reverse rotation command to the driver 36 for the motor for adjusting the position in the lateral direction of the detector located downstream of the turn bar. Then, in Step P72, the count value of the counter for detecting the position of the detector located downstream of the turn bar in conformity with the web width is loaded from the memory M6.

Then, in Step P73, the count value is loaded from the counter 38 for detecting the position in the lateral direction of the detector located downstream of the turn bar, and this count value is stored into the memory M7. Then, in Step P74, it is determined whether the count value of the counter for detecting the position of the detector located downstream of the turn bar in conformity with the web width is equal to the count value of the counter for detecting the position in the lateral direction of the detector located downstream of the turn bar.

If the answer is Y in the Step P74, Step P75 is executed to stop outputting of the reverse rotation command to the driver 36 for the motor for adjusting the position in the lateral direction of the detector located downstream of the turn bar. Then, the program shifts to Step P76 to be described later. If the answer is N in Step P74, the program returns to Step P72.

In accordance with the above-described motion flow, the position in the lateral direction of the detector 29 located downstream of the former, and the position in the lateral direction of the detector 31 located downstream of the turn bar are initialized automatically in accordance with the web width.

Then, in the aforementioned Step P76, the count value is loaded from the counter 50 for detecting the position in the lateral direction of the chopper on the former side, and is stored into the memory M24 for storing the reference count value of the counter for detecting the position in the lateral direction of the chopper on the former side. Then, in Step P77, the output of the detector 29 located downstream of the former is loaded from the A/D converter 28 connected to the detector 29 located downstream of the former, and is stored into the memory M9 for storing the reference output of the detector located downstream of the former.

Then, in the aforementioned Step P78, the count value is loaded from the counter 54 for detecting the position in the lateral direction of the chopper on the turn bar side, and is stored into the memory M25 for storing the reference count value of the counter for detecting the position in the lateral direction of the chopper on the turn bar side. Then, in Step P79, the output of the detector 31 located downstream of the turn bar is loaded from the A/D converter 30 connected to the detector 31 located downstream of the turn bar, and is stored into the memory M1 for storing the reference output of the detector located downstream of the turn bar.

Then, in Step P80, the output of the detector 29 located downstream of the former is loaded from the A/D converter 28 connected to the detector 29 located downstream of the former, and is stored into the memory M12. Then, in Step P81, the reference output of the detector located downstream of the former is loaded from the memory M9.

Then, in Step P82, the output of the detector located downstream of the former is subtracted from the reference output of the detector located downstream of the former to compute the output difference of the detector located downstream of the former, which is stored into the memory M13. Then, in Step P83, the table of conversion from the output difference of the detector located downstream of the former to the correction count value of the counter for detecting the position in the lateral direction of the chopper on the former side is loaded from the memory M26.

Then, in Step P84, the correction count value of the counter for detecting the position in the lateral direction of the chopper on the former side is found from the output difference of the detector located downstream of the former with the use of the table of conversion from the output difference of the detector located downstream of the former to the correction count value of the counter for detecting the position in the lateral direction of the chopper on the former side, and this correction count value is stored into the memory M27. Then, in Step P85, the reference count value of the counter for detecting the position in the lateral direction of the chopper on the former side is loaded from the memory M24.

Then, in Step P86, the correction count value of the counter for detecting the position in the lateral direction of the chopper on the former side is subtracted from the reference count value of the counter for detecting the position in the lateral direction of the chopper on the former side to compute the desired count value of the counter for detecting the position in the lateral direction of the chopper on the former side, and this desired count value is stored into the memory M28. Then, in Step P87, the count value is loaded from the counter 50 for detecting the position in the lateral direction of the chopper on the former side, and is stored into the memory M29.

Then, in Step P88, it is determined whether the desired count value of the counter for detecting the position in the lateral direction of the chopper on the former side is equal to the count value of the counter for detecting the position in the lateral direction of the chopper on the former side. If the answer is Y, the program shifts to Step P100 to be described later. If the answer is N, it is determined in Step P89 whether the desired count value of the counter for detecting the position in the lateral direction of the chopper on the former side is greater than the count value of the counter for detecting the position in the lateral direction of the chopper on the former side.

If the answer is Y in Step P89, Step P90 is executed to output a normal rotation command to the driver 48 for the motor for adjusting the position in the lateral direction of the chopper on the former side. Then, in Step P91, the desired count value of the counter for detecting the position in the lateral direction of the chopper on the former side is loaded from the memory M28.

Then, in Step P92, the count value is loaded from the counter 50 for detecting the position in the lateral direction of the chopper on the former side, and is stored into the memory M29. Then, in Step P93, it is determined whether the desired count value of the counter for detecting the position in the lateral direction of the chopper on the former side is equal to the count value of the counter for detecting the position in the lateral direction of the chopper on the former side.

If the answer is Y in Step P93, Step P94 is executed to stop outputting of the normal rotation command to the driver 48 for the motor for adjusting the position in the lateral direction of the chopper on the former side. Then, the program shifts to Step P100 to be described later. If the answer is N in Step P93, the program returns to Step P91.

If the answer is N in Step P89, Step P95 is executed to output a reverse rotation command to the driver 48 for the motor for adjusting the position in the lateral direction of the chopper on the former side. Then, in Step P96, the desired count value of the counter for detecting the position in the lateral direction of the chopper on the former side is loaded from the memory M28.

Then, in Step P97, the count value is loaded from the counter 50 for detecting the position in the lateral direction of the chopper on the former side, and is stored into the memory M29. Then, in Step P98, it is determined whether the desired count value of the counter for detecting the position in the lateral direction of the chopper on the former side is equal to the count value of the counter for detecting the position in the lateral direction of the chopper on the former side.

Then, if the answer is Y in Step P98, Step P99 is executed to stop outputting of the reverse rotation command to the driver 48 for the motor for adjusting the position in the lateral direction of the chopper on the former side. Then, the program shifts to Step P100 to be described later. If the answer is N in Step P98, the program returns to Step P96.

In accordance with the above-described motion flow, the position in the lateral direction of the chopper 107b on the former side is feedback-controlled responsive to the detection signal from the detector 29 located downstream of the former.

Then, in the aforementioned Step P100, the output of the detector 31 located downstream of the turn bar is loaded from the A/D converter 30 connected to the detector 31 located downstream of the turn bar, and is stored into the memory M18. Then, in Step P101, the reference output of the detector located downstream of the turn bar is loaded from the memory M11.

Then, in Step P102, the output of the detector located downstream of the turn bar is subtracted from the reference output of the detector located downstream of the turn bar to compute the output difference of the detector located downstream of the turn bar, which is stored into the memory M19. Then, in Step P103, the table of conversion from the output difference of the detector located downstream of the turn bar to the correction count value of the counter for detecting the position in the lateral direction of the chopper on the turn bar side is loaded from the memory M30.

Then, in Step P104, the correction count value of the counter for detecting the position in the lateral direction of the chopper on the turn bar side is found from the output difference of the detector located downstream of the turn bar with the use of the table of conversion from the output difference of the detector located downstream of the turn bar to the correction count value of the counter for detecting the position in the lateral direction of the chopper on the turn bar side, and this correction count value is stored into the memory M31. Then, in Step P105, the reference count value of the counter for detecting the position in the lateral direction of the chopper on the turn bar side is loaded from the memory M25.

Then, in Step P106, the correction count value of the counter for detecting the position in the lateral direction of the chopper on the turn bar side is subtracted from the reference count value of the counter for detecting the position in the lateral direction of the chopper on the turn bar side to compute the desired count value of the counter for detecting the position in the lateral direction of the chopper on the turn bar side, and this desired count value is stored into the memory M32. Then, in Step P107, the count value is loaded from the counter 54 for detecting the position in the lateral direction of the chopper on the turn bar side, and is stored into the memory M33.

Then, in Step P108, it is determined whether the desired count value of the counter for detecting the position in the lateral direction of the chopper on the turn bar side is equal to the count value of the counter for detecting the position in the lateral direction of the chopper on the turn bar side. If the answer is Y, the program shifts to Step P120 to be described later. If the answer is N, it is determined in Step P109 whether the desired count value of the counter for detecting the position in the lateral direction of the chopper on the turn bar side is greater than the count value of the counter for detecting the position in the lateral direction of the chopper on the turn bar side.

If the answer is Y in Step P109, Step P110 is executed to output a normal rotation command to the driver 52 for the motor for adjusting the position in the lateral direction of the chopper on the turn bar side. Then, in Step P111, the desired count value of the counter for detecting the position in the lateral direction of the chopper on the turn bar side is loaded from the memory M32.

Then, in Step P112, the count value is loaded from the counter 54 for detecting the position in the lateral direction of the chopper on the turn bar side, and is stored into the memory M33. Then, in Step P113, it is determined whether the desired count value of the counter for detecting the position in the lateral direction of the chopper on the turn bar side is equal to the count value of the counter for detecting the position in the lateral direction of the chopper on the turn bar side.

If the answer is Y in Step P113, Step P114 is executed to stop outputting of the normal rotation command to the driver 52 for the motor for adjusting the position in the lateral direction of the chopper on the turn bar side. Then, the program shifts to Step P120 to be described later. If the answer is N in Step P113, the program returns to Step P111.

If the answer is N in the above Step P109, Step P115 is executed to output a reverse rotation command to the driver 52 for the motor for adjusting the position in the lateral direction of the chopper on the turn bar side. Then, in Step P116, the desired count value of the counter for detecting the position in the lateral direction of the chopper on the turn bar side is loaded from the memory M32.

Then, in Step P117, the count value is loaded from the counter 54 for detecting the position in the lateral direction of the chopper on the turn bar side, and is stored into the memory M33. Then, in Step P118, it is determined whether the desired count value of the counter for detecting the position in the lateral direction of the chopper on the turn bar side is equal to the count value of the counter for detecting the position in the lateral direction of the chopper on the turn bar side.

Then, if the answer is Y in the above Step P118, Step P119 is executed to stop outputting of the reverse rotation command to the driver 52 for the motor for adjusting the position in the lateral direction of the chopper on the turn bar side. Then, the program shifts to Step P120 to be described later. If the answer is N in Step P118, the program returns to Step P116.

Then, in the aforementioned Step P120, it is determined whether the control stop switch 23 is ON. If the answer is Y, the control motion or action is terminated. If the answer is N, the program returns to Step P80. Afterwards, this procedure is repeated.

In accordance with the above-described motion flow, the position in the lateral direction of the chopper 107a on the turn bar side is feedback-controlled responsive to the detection signal from the detector 31 located downstream of the turn bar.

In the present embodiment, as described above, the positions in the lateral direction of the chopper 107b on the former side and the chopper 107a on the turn bar side are automatically adjusted in response to detection signals from the detector 29 located downstream of the former and the detector 31 located downstream of the turn bar.

Thus, the air blowing amount of the former 108 or the turn bar 101 changes according to a change in the state of the printing press, such as the rotational speed of the web rotary printing press, whereby bulging of the web Wb or Wa changes. Even if the position of the signature Sb1 or Sa1 transported to the chopper 107b or 107a of the folding machine changes on each such occasion, the position in the lateral direction of the chopper 107b on the former side or the chopper 107a on the turn bar side is automatically adjusted accordingly. As a result, the position of the signature Sb1 or Sa1 transported to the chopper 107b or 107a of the folding machine becomes always constant.

Consequently, a manual operation by the operator is not required, so that the burden on the operator is lessened, and the rate of operation is increased by automation. Furthermore, a response for position adjustment also quickens to decrease the occurrence of wasted paper and curb its increase.

The present embodiment illustrates the web rotary printing press in which the webs Wa, Wb are transported, respectively, to the choppers 107a, 107b of the folding machine via the turn bar 101 and the former 108. Needless to say, however, the present invention can be applied to a web rotary printing press having the turn bar or turn bars 101 in one path or two paths, or the former or formers 108 in one path or two paths.

It goes without saying that the present invention is not limited to the above embodiments, and various changes and modifications may be made without departing from the gist of the present invention. For example, the present invention can be applied to machines for producing or processing strip-shaped materials (webs), such as plastic films and thin steel sheets, instead of paper in printing presses. Such variations are not to be regarded as a departure from the spirit and scope of the invention, and all such modifications as would be obvious to one skilled in the art are intended to be included within the scope of the following claims.

What is claimed is:

1. A control apparatus for a strip-shaped material printing press which includes,
printing means for printing a pattern on a strip-shaped material,
a former for folding the strip-shaped material, which has been printed by the printing means, in a direction parallel to a strip-shaped material transport direction,
cutting means for cutting the strip-shaped material, which has been folded by the former, in a direction orthogonal to the strip-shaped material transport direction to form a signature, and
a chopper folding device for refolding the signature, which has been formed by the cutting means, in a direction parallel to a signature transport direction,
the control apparatus, comprising:
paper end detecting means, provided halfway through a transport path for the strip-shaped material or the signature from the former to the chopper folding device, for detecting a position of an end portion of the strip-shaped material on a side folded by the former; and
control means for adjusting a position, in the strip-shaped material transport direction, of the former or a position, in a direction orthogonal to the signature transport direction, of the chopper folding device in response to an output from the paper end detecting means.

2. A control apparatus for a strip-shaped material printing press which includes,
printing means for printing a pattern on a strip-shaped material,
a turn bar for changing a transport direction of the strip-shaped material,
cutting means for cutting the strip-shaped material, which has been changed in the transport direction by the turn bar, in a direction orthogonal to the strip-shaped material transport direction to form a signature, and
a chopper folding device for folding the signature, which has been formed by the cutting means, in a direction parallel to a signature transport direction,
the control apparatus, comprising:
paper end detecting means, provided halfway through a transport path for the strip-shaped material or the signature from the turn bar to the chopper folding device, for detecting a position of an end portion of the strip-shaped material or the signature parallel to the transport direction; and
control means for adjusting a position, in the strip-shaped material transport direction, of the turn bar or a position, in a direction orthogonal to the signature transport direction, of the chopper folding device in response to an output from the paper end detecting means.

3. A control method for a strip-shaped material printing press which includes,
printing means for printing a pattern on a strip-shaped material,
a former for folding the strip-shaped material, which has been printed by the printing means, in a direction parallel to a strip-shaped material transport direction,
cutting means for cutting the strip-shaped material, which has been folded by the former, in a direction orthogonal to the strip-shaped material transport direction to form a signature, and
a chopper folding device for refolding the signature, which has been formed by the cutting means, in a direction parallel to a signature transport direction,
the control method, comprising:
detecting a position of an end portion of the strip-shaped material on a side folded by the former, halfway through a transport path for the strip-shaped material or the signature from the former to the chopper folding device; and
adjusting a position, in the strip-shaped material transport direction, of the former or a position, in a direction orthogonal to the signature transport direction, of the chopper folding device in accordance with results of detection.

4. A control method for a strip-shaped material printing press which includes,
printing means for printing a pattern on a strip-shaped material,
a turn bar for changing a transport direction of the strip-shaped material,
cutting means for cutting the strip-shaped material, which has been changed in the transport direction by the turn bar, in a direction orthogonal to the strip-shaped material transport direction to form a signature, and
a chopper folding device for folding the signature, which has been formed by the cutting means, in a direction parallel to a signature transport direction,
the control method, comprising:
detecting a position of an end portion of the strip-shaped material or the signature parallel to the transport direction, halfway through a transport path for the strip-shaped material or the signature from the turn bar to the chopper folding device; and
adjusting a position, in the strip-shaped material transport direction, of the turn bar or a position, in a direction orthogonal to the signature transport direction, of the chopper folding device in accordance with results of detection.
